(19) United States
(12) Patent Application Publication
(10) Pub. No.: US 2011/0228004 A1
(43) Pub. Date: Sep. 22, 2011

(54) METHOD OF HYDROPHOBIZING EJECTION FACE OF PRINTHEAD

(75) Inventor: Kia Silverbrook, Balmain (AU)

(73) Assignee: Silverbrook Research Pty Ltd

(21) Appl. No.: 13/118,459

(22) Filed: May 30, 2011

Related U.S. Application Data
(63) Continuation of application No. 12/264,903, filed on Nov. 4, 2008, now Pat. No. 7,984,972.
Application No. 12/264,903 is a continuation of application No. 12/017,771, filed on Jan. 22, 2008, now Pat. No. 7,469,997.
Application No. 12/017,771 is a continuation of application No. 11/097,266, filed on Apr. 4, 2005, now Pat. No. 7,344,226.

(51) Int. Cl. B41J 2/135

(52) U.S. Cl. 347/45

(57) ABSTRACT

A method of hydrophobizing an ejection face of a printhead is provided which avoids hydrophobizing fluid distribution structures of the printhead. The method involves (a) filling fluid distribution structures of the printhead exposed to the ejection face with a liquid, and (b) depositing a hydrophobizing material onto the ejection face of the printhead, provided that step (a) is performed prior to step (b).

### CROSS REFERENCE TO RELATED APPLICATION

This application is a continuation of U.S. application Ser. No. 12/264,903 filed Nov. 4, 2008, which is a continuation of Ser. No. 12/017,771 filed on Jan. 22, 2008, now issued U.S. Pat. No. 7,469,997, which is a continuation application of U.S. patent application Ser. No. 11/097,266 filed on Apr. 4, 2005, now issued U.S. Pat. No. 7,344,226, all of which is herein incorporated by reference.

### CO-PENDING APPLICATIONS

The following application has been filed by the Applicant with U.S. Pat. No. 7,344,226:
U.S. Pat. No. 7,328,976

The disclosure of this co-pending application are incorporated herein by reference.

### CROSS REFERENCES TO RELATED APPLICATIONS

The following patents or patent applications filed by the applicant or assignee of the present invention are hereby incorporated by cross-reference.

| | | | | |
|---|---|---|---|---|
| 6,750,901 | 6,476,863 | 6,788,336 | 7,364,256 | 7,258,417 |
| 7,293,853 | 7,328,968 | 7,270,395 | 7,461,916 | 7,510,264 |
| 7,334,864 | 7,255,419 | 7,284,819 | 7,229,148 | 7,258,416 |
| 7,273,263 | 7,270,393 | 6,984,017 | 7,347,526 | 7,357,477 |
| 7,465,015 | 7,364,255 | 7,357,476 | 7,758,148 | 7,284,820 |
| 7,341,328 | 7,246,875 | 7,322,669 | 6,623,101 | 6,406,129 |
| 6,505,916 | 6,457,809 | 6,550,895 | 6,457,812 | 7,152,962 |
| 6,428,133 | 7,204,941 | 7,282,164 | 7,465,342 | 7,278,727 |
| 7,417,141 | 7,452,989 | 7,367,665 | 7,138,391 | 7,153,956 |
| 7,423,145 | 7,456,277 | 7,550,585 | 7,122,076 | 7,148,345 |
| 7,416,280 | 7,156,508 | 7,159,972 | 7,083,271 | 7,165,834 |
| 7,080,894 | 7,201,469 | 7,090,336 | 7,156,489 | 7,413,283 |
| 7,438,385 | 7,083,257 | 7,258,422 | 7,255,423 | 7,219,980 |
| 7,591,533 | 7,416,274 | 7,367,649 | 7,118,192 | 7,618,121 |
| 7,322,672 | 7,077,505 | 7,198,354 | 7,077,504 | 7,614,724 |
| 7,198,355 | 7,401,894 | 7,322,676 | 7,152,959 | 7,213,906 |
| 7,178,901 | 7,222,938 | 7,108,353 | 7,104,629 | 7,246,886 |
| 7,128,400 | 7,108,355 | 6,991,322 | 7,287,836 | 7,118,197 |
| 7,575,298 | 7,364,269 | 7,077,493 | 6,962,402 | 7,686,429 |
| 7,147,308 | 7,524,034 | 7,118,198 | 7,168,790 | 7,172,270 |
| 7,229,155 | 6,830,318 | 7,195,342 | 7,175,261 | 7,465,035 |
| 7,108,356 | 7,118,202 | 7,510,269 | 7,134,744 | 7,510,270 |
| 7,134,743 | 7,182,439 | 7,210,768 | 7,465,036 | 7,134,745 |
| 7,156,484 | 7,118,201 | 7,111,926 | 7,431,433 | 7,018,021 |
| 7,401,901 | 7,468,139 | 7,721,948 | 7,079,712 | 6,825,945 |
| 7,330,974 | 6,813,039 | 6,987,506 | 7,038,797 | 6,980,318 |
| 6,816,274 | 7,102,772 | 7,350,236 | 6,681,045 | 6,728,000 |
| 7,173,722 | 7,088,459 | 7,707,082 | 7,068,382 | 7,062,651 |
| 6,789,194 | 6,789,191 | 6,644,642 | 6,502,614 | 6,622,999 |
| 6,669,385 | 6,549,935 | 6,987,573 | 6,727,996 | 6,591,884 |
| 6,439,706 | 6,760,119 | 7,295,332 | 6,290,349 | 6,428,155 |
| 6,785,016 | 6,870,966 | 6,822,639 | 6,737,591 | 7,055,739 |
| 7,233,320 | 6,830,196 | 6,832,717 | 6,957,768 | 7,170,499 |
| 7,106,888 | 7,377,608 | 7,399,043 | 7,121,639 | 7,165,824 |
| 7,152,942 | 7,818,519 | 7,181,572 | 7,096,137 | 7,302,592 |
| 7,278,034 | 7,188,282 | 7,592,829 | 7,770,008 | 7,707,621 |
| 7,523,111 | 7,573,301 | 7,660,998 | 7,783,886 | 7,831,827 |
| 7,369,270 | 6,795,215 | 7,070,098 | 7,154,638 | 6,805,419 |
| 6,859,289 | 6,977,751 | 6,398,332 | 6,394,573 | 6,622,923 |
| 6,747,760 | 6,921,144 | 7,092,112 | 7,192,106 | 7,374,266 |
| 7,427,117 | 7,448,707 | 7,281,330 | 7,328,956 | 7,735,944 |
| 7,188,928 | 7,093,989 | 7,377,609 | 7,600,843 | 10/854,498 |
| 7,390,071 | 7,549,715 | 7,252,353 | 7,607,757 | 7,267,417 |
| 7,517,036 | 7,275,805 | 7,314,261 | 7,281,777 | 7,290,852 |
| 7,484,831 | 7,758,143 | 7,832,842 | 7,549,718 | 7,866,778 |
| 7,631,190 | 7,557,941 | 7,757,086 | 7,266,661 | 7,243,193 |
| 7,448,734 | 7,425,050 | 7,364,263 | 7,201,468 | 7,360,868 |
| 7,234,802 | 7,303,255 | 7,287,846 | 7,156,511 | 7,258,432 |
| 7,097,291 | 7,645,025 | 7,083,273 | 7,367,647 | 7,374,355 |
| 7,441,880 | 7,547,092 | 7,513,598 | 7,198,352 | 7,364,264 |
| 7,303,251 | 7,201,470 | 7,121,655 | 7,293,861 | 7,232,208 |
| 7,328,985 | 7,344,232 | 7,083,272 | 7,621,620 | 7,669,961 |
| 7,331,663 | 7,360,861 | 7,328,973 | 7,427,121 | 7,407,262 |
| 7,303,252 | 7,249,822 | 7,537,309 | 7,311,382 | 7,360,860 |
| 7,364,257 | 7,390,075 | 7,350,896 | 7,429,096 | 7,384,135 |
| 7,331,660 | 7,416,287 | 7,488,052 | 7,322,684 | 7,322,685 |
| 7,311,381 | 7,270,405 | 7,303,268 | 7,470,007 | 7,399,072 |
| 7,393,076 | 7,681,967 | 7,588,301 | 7,249,833 | 7,524,016 |
| 7,490,927 | 7,331,661 | 7,524,043 | 7,300,140 | 7,357,492 |
| 7,357,493 | 7,566,106 | 7,380,902 | 7,284,816 | 7,284,845 |
| 7,255,430 | 7,390,080 | 7,328,984 | 7,350,913 | 7,322,671 |
| 7,380,910 | 7,431,424 | 7,470,006 | 7,585,054 | 7,347,534 |
| 7,258,417 | 7,293,853 | 6,750,901 | 6,476,863 | 6,788,336 |
| 7,364,256 | 7,334,864 | 7,255,419 | 7,328,968 | 7,270,395 |
| 7,461,916 | 7,510,264 | 7,270,393 | 6,984,017 | 7,284,819 |
| 7,229,148 | 7,258,416 | 7,273,263 | 7,357,476 | 7,758,148 |
| 7,347,526 | 7,357,477 | 7,246,875 | 7,364,255 | 6,623,101 |
| 6,406,129 | 7,284,820 | 7,341,328 | 6,550,895 | 7,322,669 |
| 7,152,962 | 6,428,133 | 6,505,916 | 6,457,809 | 7,465,342 |
| 6,457,812 | 7,417,141 | 7,452,989 | 7,204,941 | 7,282,164 |
| 7,153,956 | 7,278,727 | 7,456,277 | 7,550,585 | 7,367,665 |
| 7,138,391 | 7,416,280 | 7,423,145 | 7,159,972 | 7,083,271 |
| 7,122,076 | 7,148,345 | 7,201,469 | 7,156,508 | 7,156,489 |
| 7,413,283 | 7,165,834 | 7,080,894 | 7,258,422 | 7,090,336 |
| 7,219,980 | 7,591,533 | 7,438,385 | 7,083,257 | 7,118,192 |
| 7,255,423 | 7,322,672 | 7,077,505 | 7,416,274 | 7,367,649 |
| 7,614,724 | 7,618,121 | 7,401,894 | 7,322,676 | 7,198,354 |
| 7,077,504 | 7,178,901 | 7,198,355 | 7,108,353 | 7,104,629 |
| 7,152,959 | 7,213,906 | 7,108,355 | 7,222,938 | 7,287,836 |
| 7,118,197 | 7,246,886 | 7,128,400 | 7,077,493 | 6,991,322 |
| 7,686,429 | 7,147,308 | 7,575,298 | 7,364,269 | 7,168,790 |
| 6,962,402 | 7,229,155 | 6,830,318 | 7,524,034 | 7,118,198 |
| 7,465,035 | 7,172,270 | 7,118,202 | 7,510,269 | 7,195,342 |
| 7,175,261 | 7,134,743 | 7,108,356 | 7,210,768 | 7,465,036 |
| 7,134,744 | 10/773,185 | 7,118,201 | 7,182,439 | 7,431,433 |
| 7,018,021 | 7,134,745 | 7,156,484 | 7,721,948 | 7,111,926 |
| 6,825,945 | 7,330,974 | 7,401,901 | 11/060,805 | 7,038,797 |
| 7,079,712 | 6,816,274 | 7,102,772 | 6,813,039 | 6,987,506 |
| 6,728,000 | 6,980,318 | 7,088,459 | 7,707,082 | 7,350,236 |
| 6,681,045 | 6,789,194 | 7,173,722 | 6,644,642 | 6,502,614 |
| 7,068,382 | 7,062,651 | 6,549,935 | 6,789,191 | 6,727,996 |
| 6,591,884 | 6,622,999 | 6,669,385 | 7,295,332 | 6,987,573 |
| 6,428,155 | 6,785,016 | 6,439,706 | 6,760,119 | 6,737,591 |
| 6,290,349 | 7,233,320 | 6,830,196 | 6,870,966 | 6,822,639 |
| 7,170,499 | 7,055,739 | 7,152,942 | 7,818,519 | 6,832,717 |
| 6,957,768 | 7,121,639 | 7,106,888 | 7,188,282 | 7,592,829 |
| 7,377,608 | 7,399,043 | 7,302,592 | 7,165,824 | 7,707,621 |
| 7,523,111 | 7,181,572 | 7,096,137 | 7,783,886 | 7,278,034 |
| 6,805,419 | 6,859,289 | 7,573,301 | 10/727,179 | 7,070,098 |
| 7,770,008 | 6,747,760 | 6,921,144 | 7,369,270 | 10/727,158 |
| 6,394,573 | 7,831,827 | 7,427,117 | 7,448,707 | 6,977,751 |
| 6,795,215 | 7,192,106 | 7,154,638 | 7,188,928 | 7,093,989 |
| 7,281,330 | 6,398,332 | 7,328,956 | 6,622,923 | 7,390,071 |
| 7,290,852 | 7,377,609 | 7,092,112 | 10/854,498 | 7,374,266 |
| 7,267,417 | 7,631,190 | 7,517,036 | 10/854,503 | 7,252,353 |
| 7,735,944 | 7,281,777 | 7,243,193 | 7,484,831 | 10/854,495 |
| 7,314,261 | 7,607,757 | 7,866,778 | 7,364,263 | 7,557,941 |
| 10/854,516 | 7,832,842 | 7,549,718 | 7,266,661 | 7,287,846 |
| 7,201,468 | 7,275,805 | 7,757,086 | 7,448,734 | 7,425,050 |
| 7,201,470 | 7,156,511 | 10/854,523 | 7,258,432 | 7,234,802 |
| 7,303,255 | 7,083,272 | 7,083,273 | 10/854,513 | 7,374,355 |
| 7,097,291 | 7,645,025 | 7,427,121 | 7,513,598 | 10/854,517 |
| 7,198,352 | 7,441,880 | 7,547,092 | 7,360,860 | 7,121,655 |
| 7,360,868 | 7,232,208 | 7,364,264 | 7,303,251 | 7,331,660 |
| 7,621,620 | 10/760,264 | 7,331,663 | 7,328,985 | 7,344,232 |
| 7,270,405 | 7,407,262 | 7,367,647 | 7,249,822 | 7,360,861 |
| 7,328,973 | 7,588,301 | 7,364,257 | 10/760,270 | 7,350,896 |
| 7,537,309 | 7,311,382 | 7,300,140 | 7,416,287 | 7,293,861 |
| 7,322,684 | 7,429,096 | 7,384,135 | 7,284,845 | 7,303,268 |
| 11/014,763 | 7,399,072 | 7,322,685 | 7,311,381 | 7,380,910 |
| 7,249,833 | 7,303,252 | 7,490,927 | 7,393,076 | 7,681,967 |
| 7,284,816 | 7,357,492 | 7,390,075 | 7,566,106 | 7,331,661 |
| 7,524,043 | 7,322,671 | 7,255,430 | 7,488,052 | 7,328,984 |
| 7,380,902 | 7,347,534 | 7,357,493 | 7,431,424 | 7,470,007 |
| 7,585,054 | 7,350,913 | 7,390,080 | 7,470,006 | 7,524,016 |

### FIELD OF THE INVENTION

The present invention relates to the field of inkjet printers and, discloses an inkjet printing system using printheads manufactured with microelectro-mechanical systems (MEMS) techniques.

### BACKGROUND OF THE INVENTION

Many different types of printing have been invented, a large number of which are presently in use. The known forms of print have a variety of methods for marking the print media with a relevant marking media. Commonly used forms of printing include offset printing, laser printing and copying devices, dot matrix type impact printers, thermal paper printers, film recorders, thermal wax printers, dye sublimation printers and ink jet printers both of the drop on demand and continuous flow type. Each type of printer has its own advantages and problems when considering cost, speed, quality, reliability, simplicity of construction and operation etc.

In recent years, the field of ink jet printing, wherein each individual pixel of ink is derived from one or more ink nozzles has become increasingly popular primarily due to its inexpensive and versatile nature.

Many different techniques on ink jet printing have been invented. For a survey of the field, reference is made to an article by J Moore, “Non-Impact Printing: Introduction and Historical Perspective”, Output Hard Copy Devices, Editors R Dubeck and S Sherr, pages 207-220 (1988).

Ink Jet printers themselves come in many different types. The utilization of a continuous stream of ink in ink jet printing appears to date back to at least 1929 wherein U.S. Pat. No. 1,941,001 by Hansell discloses a simple form of continuous stream electro-static ink jet printing.

U.S. Pat. No. 3,596,275 by Sweet also discloses a process of a continuous ink jet printing including the step wherein the ink jet stream is modulated by a high frequency electro-static field so as to cause drop separation. This technique is still utilized by several manufacturers including Elmjet and Scitex (see also U.S. Pat. No. 3,373,437 by Sweet et al)

Piezoelectric ink jet printers are also one form of commonly utilized ink jet printing device. Piezoelectric systems are disclosed by Kyser et. al. in U.S. Pat. No. 3,946,398 (1970) which utilizes a diaphragm mode of operation, by Zolten in U.S. Pat. No. 3,683,212 (1970) which discloses a squeeze mode of operation of a piezoelectric crystal, Stemme in U.S. Pat. No. 3,747,120 (1972) discloses a bend mode of piezoelectric operation, Howkins in U.S. Pat. No. 4,459,601 discloses a piezoelectric push mode actuation of the ink jet stream and Fischbeck in U.S. Pat. No. 4,584,590 which discloses a shear mode type of piezoelectric transducer element.

Recently, thermal ink jet printing has become an extremely popular form of ink jet printing. The ink jet printing techniques include those disclosed by Endo et al in GB 2007162 (1979) and Vaught et al in U.S. Pat. No. 4,490,728. Both the aforementioned references disclosed ink jet printing techniques that rely upon the activation of an electrothermal actuator which results in the creation of a bubble in a constricted space, such as a nozzle, which thereby causes the ejection of ink from an aperture connected to the confined space onto a relevant print media. Printing devices utilizing the electro-thermal actuator are manufactured by manufacturers such as Canon and Hewlett Packard.

As can be seen from the foregoing, many different types of printing technologies are available. Ideally, a printing technology should have a number of desirable attributes. These include inexpensive construction and operation, high speed operation, safe and continuous long term operation etc. Each technology may have its own advantages and disadvantages in the areas of cost, speed, quality, reliability, power usage, simplicity of construction operation, durability and consumables.

In the construction of any inkjet printing system, there are a considerable number of important factors which must be traded off against one another especially as large scale printheads are constructed, especially those of a pagewidth type. A number of these factors are outlined in the following paragraphs.

Firstly, inkjet printheads are normally constructed utilizing micro-electromechanical systems (MEMS) techniques. As such, they tend to rely upon standard integrated circuit construction/fabrication techniques of depositing planar layers on a silicon wafer and etching certain portions of the planar layers. Within silicon circuit fabrication technology, certain techniques are better known than others. For example, the techniques associated with the creation of CMOS circuits are likely to be more readily used than those associated with the creation of exotic circuits including ferroelectrics, galium arsenide etc. Hence, it is desirable, in any MEMS constructions, to utilize well proven semi-conductor fabrication techniques which do not require any “exotic” processes or materials. Of course, a certain degree of trade off will be undertaken in that if the advantages of using the exotic material far out weighs its disadvantages then it may become desirable to utilize the material anyway. However, if it is possible to achieve the same, or similar, properties using more common materials, the problems of exotic materials can be avoided.

A desirable characteristic of inkjet printheads would be a hydrophobic nozzle (front) face, preferably in combination with hydrophilic nozzle chambers and ink supply channels. This combination is optimal for ink ejection. Moreover, a hydrophobic front face minimizes the propensity for ink to flood across the front face of the printhead. With a hydrophobic front face, the aqueous inkjet ink is less likely to flood sideways out of the nozzle openings and more likely to form spherical, ejectable microdroplets.

However, whilst hydrophobic front faces and hydrophilic ink chambers are desirable, there is a major problem in fabricating such printheads by MEMS techniques. The final stage of MEMS printhead fabrication is typically ashing of photoresist using an oxygen plasma. However, any organic, hydrophobic material deposited onto the front face will typically be removed by the ashing process to leave a hydrophilic surface. Accordingly, the deposition of hydrophobic material needs to occur after ashing. However, a problem with post-ashing deposition of hydrophobic materials is that the hydrophobic material will be deposited inside nozzle chambers as well as on the front face of the printhead. With no photoresist to protect the nozzle chambers, the nozzle chamber walls become hydrophobized, which is highly undesirable in terms of generating a positive ink pressure biased towards the nozzle chambers. This is a conundrum, which has to date not been addressed in printhead fabrication.

Accordingly, it would be desirable to provide a printhead fabrication process, in which the resultant printhead chip has improved surface characteristics, without comprising the surface characteristics of nozzle chambers. It would further be desirable to provide a printhead fabrication process, in which the resultant printhead chip has a hydrophobic front face in combination with hydrophilic nozzle chambers.

### SUMMARY OF THE INVENTION

In a first aspect, there is provided a printhead comprising a plurality of nozzles formed on a substrate, each nozzle comprising a nozzle chamber, a nozzle opening defined in a roof of the nozzle chamber and an actuator for ejecting ink through the nozzle opening, wherein at least part of an ink ejection face of the printhead is hydrophobic relative to the inside surfaces of each nozzle chamber.

In a second aspect, there is provided a method of hydrophobizing an ink ejection face of a printhead, whilst avoiding hydrophobizing nozzle chambers and/or ink supply channels, the method comprising the steps of:

(a) filling nozzle chambers on the printhead with a liquid; and

(b) depositing a hydrophobizing material onto the ink ejection face of the printhead.

### BRIEF DESCRIPTION OF THE DRAWINGS

Notwithstanding any other forms that may fall within the scope of the present invention, preferred forms of the invention will now be described, by way of example only, with reference to the accompanying drawings in which:

FIG. 1 is a schematic cross-sectional view through an ink chamber of a unit cell of a printhead according to an embodiment using a bubble forming heater element;

FIG. 2 is a schematic cross-sectional view through the ink chamber FIG. 1, at another stage of operation;

FIG. 3 is a schematic cross-sectional view through the ink chamber FIG. 1, at yet another stage of operation;

FIG. 4 is a schematic cross-sectional view through the ink chamber FIG. 1, at yet a further stage of operation; and

FIG. 5 is a diagrammatic cross-sectional view through a unit cell of a printhead in accordance with an embodiment of the invention showing the collapse of a vapor bubble.

FIG. 6 is a schematic, partially cut away, perspective view of a further embodiment of a unit cell of a printhead.

FIG. 7 is a schematic, partially cut away, exploded perspective view of the unit cell of FIG. 6.

FIG. 8 is a schematic, partially cut away, perspective view of a further embodiment of a unit cell of a printhead.

FIG. 9 is a schematic, partially cut away, exploded perspective view of the unit cell of FIG. 8.

FIG. 10 is a schematic, partially cut away, perspective view of a further embodiment of a unit cell of a printhead.

FIG. 11 is a schematic, partially cut away, exploded perspective view of the unit cell of FIG. 10.

FIG. 12 is a schematic, partially cut away, perspective view of a further embodiment of a unit cell of a printhead.

FIG. 13 is a schematic, partially cut away, perspective view of a further embodiment of a unit cell of a printhead.

FIG. 14 is a schematic, partially cut away, exploded perspective view of the unit cell of FIG. 13.

FIGS. 15 to 25 are schematic perspective views of the unit cell shown in FIGS. 13 and 14, at various successive stages in the production process of the printhead.

FIG. 26 shows partially cut away schematic perspective views of the unit cell of FIG. 25.

FIG. 27 shows the unit cell of FIG. 25 primed with a fluid.

FIG. 28 shows the unit cell of FIG. 27 with a hydrophobic coating on the nozzle plate

### DESCRIPTION OF OPTIONAL EMBODIMENTS

### Bubble Forming Heater Element Actuator

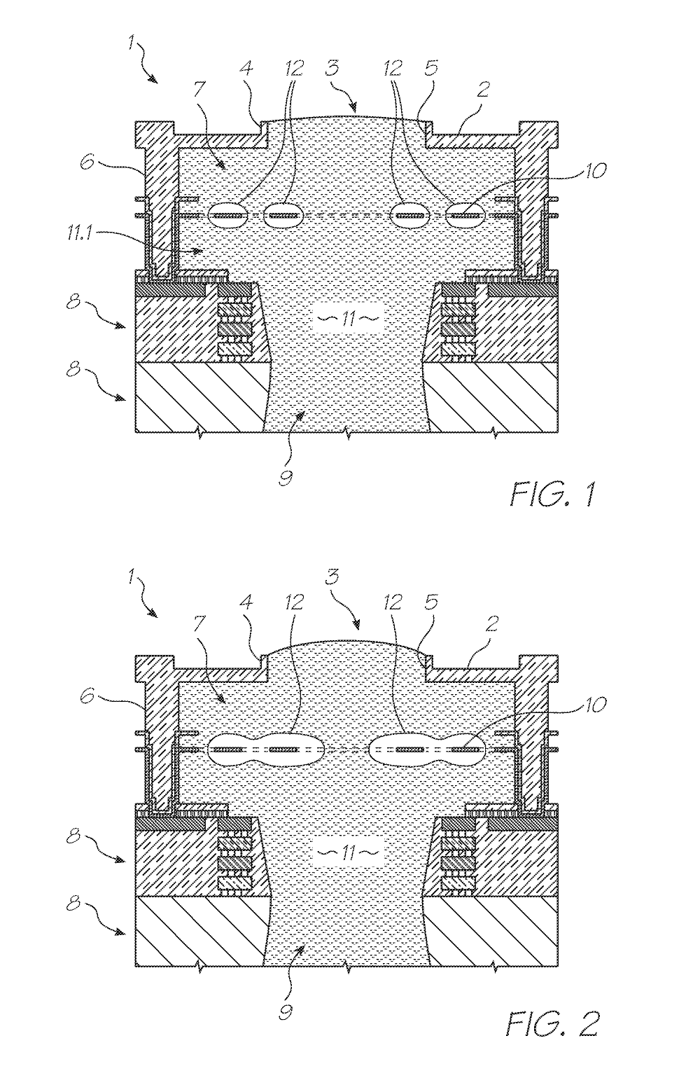

With reference to FIGS. 1 to 4, the unit cell 1 of a printhead according to an embodiment of the invention comprises a nozzle plate 2 with nozzles 3 therein, the nozzles having nozzle rims 4, and apertures 5 extending through the nozzle plate. The nozzle plate 2 is plasma etched from a silicon nitride structure which is deposited, by way of chemical vapor deposition (CVD), over a sacrificial material which is subsequently etched.

The printhead also includes, with respect to each nozzle 3, side walls 6 on which the nozzle plate is supported, a chamber 7 defined by the walls and the nozzle plate 2, a multi-layer substrate 8 and an inlet passage 9 extending through the multi-layer substrate to the far side (not shown) of the substrate. A looped, elongate heater element 10 is suspended within the chamber 7, so that the element is in the form of a suspended beam. The printhead as shown is a microelectromechanical system (MEMS) structure, which is formed by a lithographic process which is described in more detail below.

When the printhead is in use, ink 11 from a reservoir (not shown) enters the chamber 7 via the inlet passage 9, so that the chamber fills to the level as shown in FIG. 1. Thereafter, the heater element 10 is heated for somewhat less than 1 microsecond, so that the heating is in the form of a thermal pulse. It will be appreciated that the heater element 10 is in thermal contact with the ink 11 in the chamber 7 so that when the element is heated, this causes the generation of vapor bubbles 12 in the ink. Accordingly, the ink 11 constitutes a bubble forming liquid. FIG. 1 shows the formation of a bubble 12 approximately 1 microsecond after generation of the thermal pulse, that is, when the bubble has just nucleated on the heater elements 10. It will be appreciated that, as the heat is applied in the form of a pulse, all the energy necessary to generate the bubble 12 is to be supplied within that short time.

When the element 10 is heated as described above, the bubble 12 forms along the length of the element, this bubble appearing, in the cross-sectional view of FIG. 1, as four bubble portions, one for each of the element portions shown in cross section.

The bubble 12, once generated, causes an increase in pressure within the chamber 7, which in turn causes the ejection of a drop 16 of the ink 11 through the nozzle 3. The rim 4 assists in directing the drop 16 as it is ejected, so as to minimize the chance of drop misdirection.

The reason that there is only one nozzle 3 and chamber 7 per inlet passage 9 is so that the pressure wave generated within the chamber, on heating of the element 10 and forming of a bubble 12, does not affect adjacent chambers and their corresponding nozzles. The pressure wave generated within the chamber creates significant stresses in the chamber wall. Forming the chamber from an amorphous ceramic such as silicon nitride, silicon dioxide (glass) or silicon oxynitride, gives the chamber walls high strength while avoiding the use of material with a crystal structure. Crystalline defects can act as stress concentration points and therefore potential areas of weakness and ultimately failure.

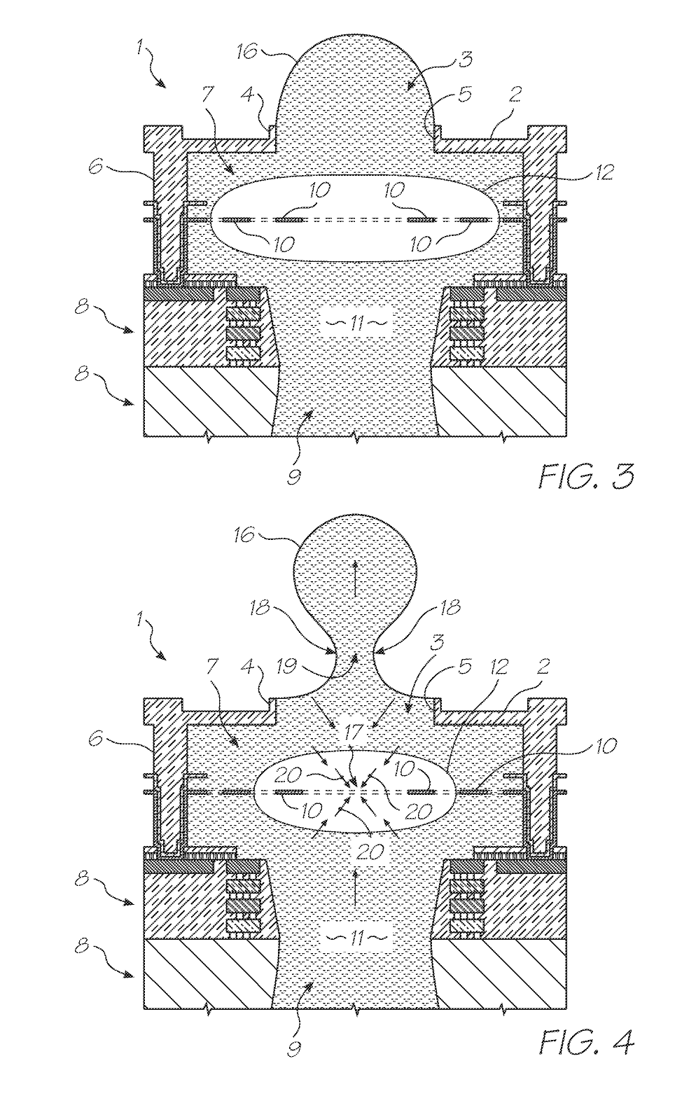

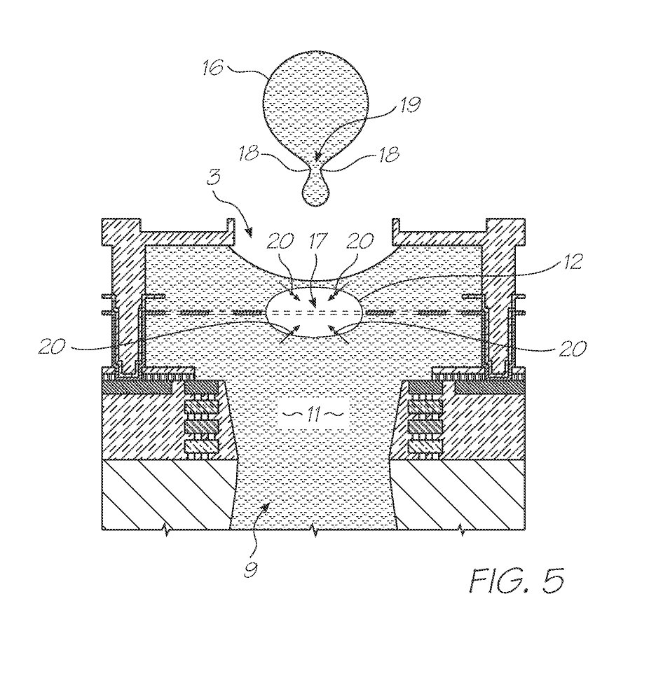

FIGS. 2 and 3 show the unit cell 1 at two successive later stages of operation of the printhead. It can be seen that the bubble 12 generates further, and hence grows, with the resultant advancement of ink 11 through the nozzle 3. The shape of the bubble 12 as it grows, as shown in FIG. 3, is determined by a combination of the inertial dynamics and the surface tension of the ink 11. The surface tension tends to minimize the surface area of the bubble 12 so that, by the time a certain amount of liquid has evaporated, the bubble is essentially disk-shaped.

The increase in pressure within the chamber 7 not only pushes ink 11 out through the nozzle 3, but also pushes some ink back through the inlet passage 9. However, the inlet passage 9 is approximately 200 to 300 microns in length, and is only approximately 16 microns in diameter. Hence there is a substantial viscous drag. As a result, the predominant effect of the pressure rise in the chamber 7 is to force ink out through the nozzle 3 as an ejected drop 16, rather than back through the inlet passage 9.

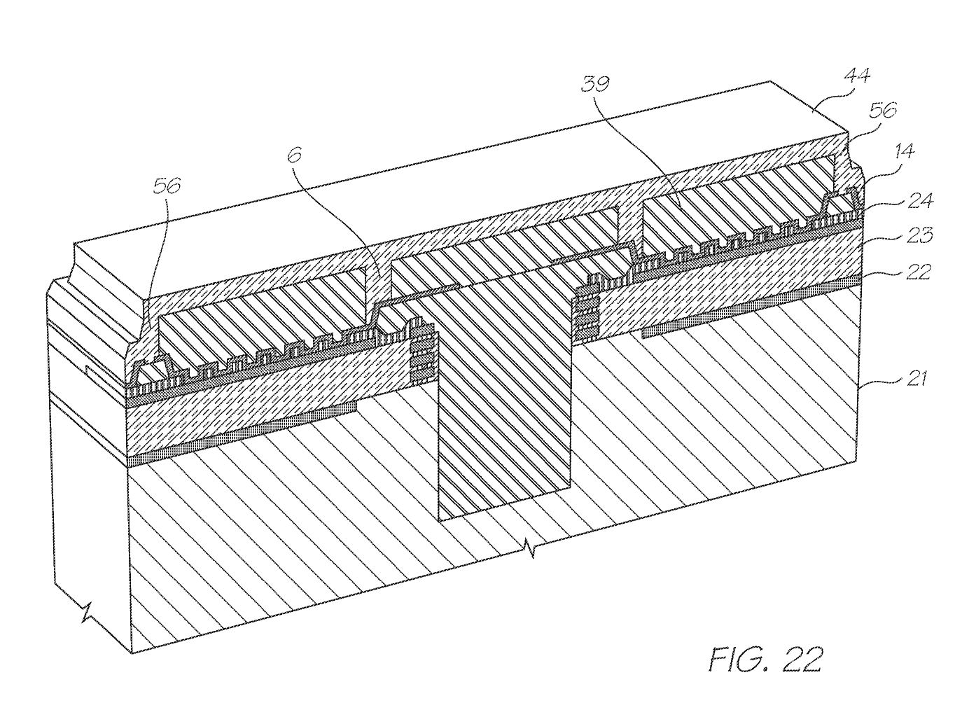

Turning now to FIG. 4, the printhead is shown at a still further successive stage of operation, in which the ink drop 16 that is being ejected is shown during its “necking phase” before the drop breaks off. At this stage, the bubble 12 has already reached its maximum size and has then begun to collapse towards the point of collapse 17, as reflected in more detail in FIG. 21.

The collapsing of the bubble 12 towards the point of collapse 17 causes some ink 11 to be drawn from within the nozzle 3 (from the sides 18 of the drop), and some to be drawn from the inlet passage 9, towards the point of collapse. Most of the ink 11 drawn in this manner is drawn from the nozzle 3, forming an annular neck 19 at the base of the drop 16 prior to its breaking off.

The drop 16 requires a certain amount of momentum to overcome surface tension forces, in order to break off. As ink 11 is drawn from the nozzle 3 by the collapse of the bubble 12, the diameter of the neck 19 reduces thereby reducing the amount of total surface tension holding the drop, so that the momentum of the drop as it is ejected out of the nozzle is sufficient to allow the drop to break off.

When the drop 16 breaks off, cavitation forces are caused as reflected by the arrows 20, as the bubble 12 collapses to the point of collapse 17. It will be noted that there are no solid surfaces in the vicinity of the point of collapse 17 on which the cavitation can have an effect.

### Features and Advantages of Further Embodiments

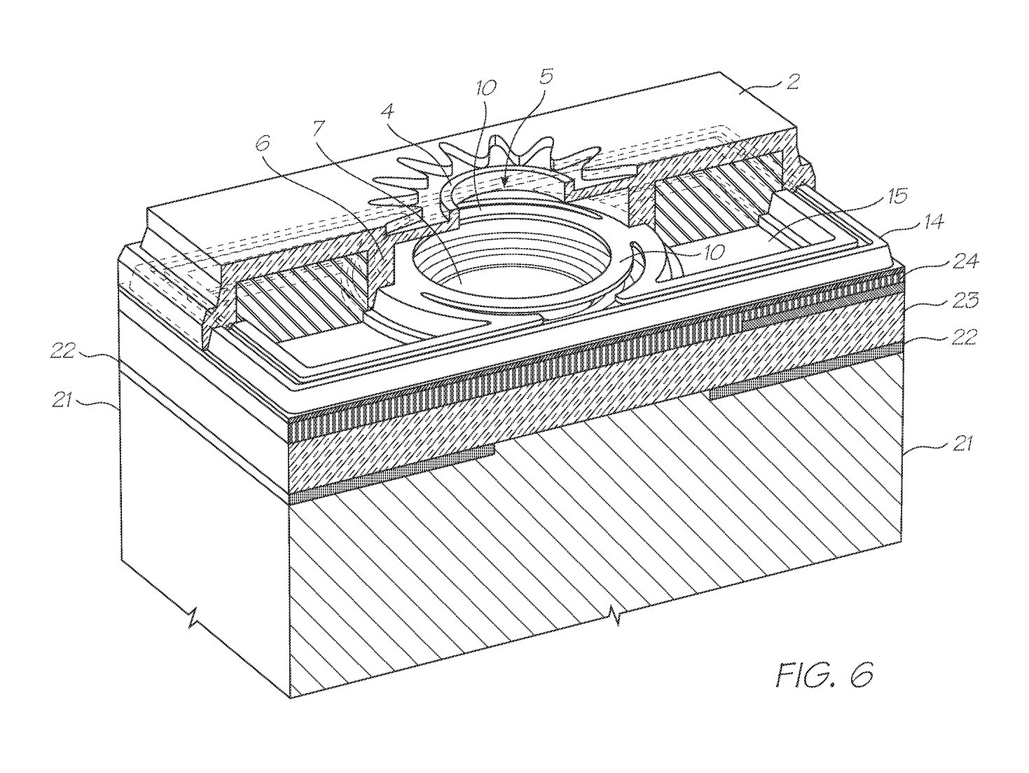

FIGS. 6 to 29 show further embodiments of unit cells 1 for thermal inkjet printheads, each embodiment having its own particular functional advantages. These advantages will be discussed in detail below, with reference to each individual embodiment. For consistency, the same reference numerals are used in FIGS. 6 to 29 to indicate corresponding components.

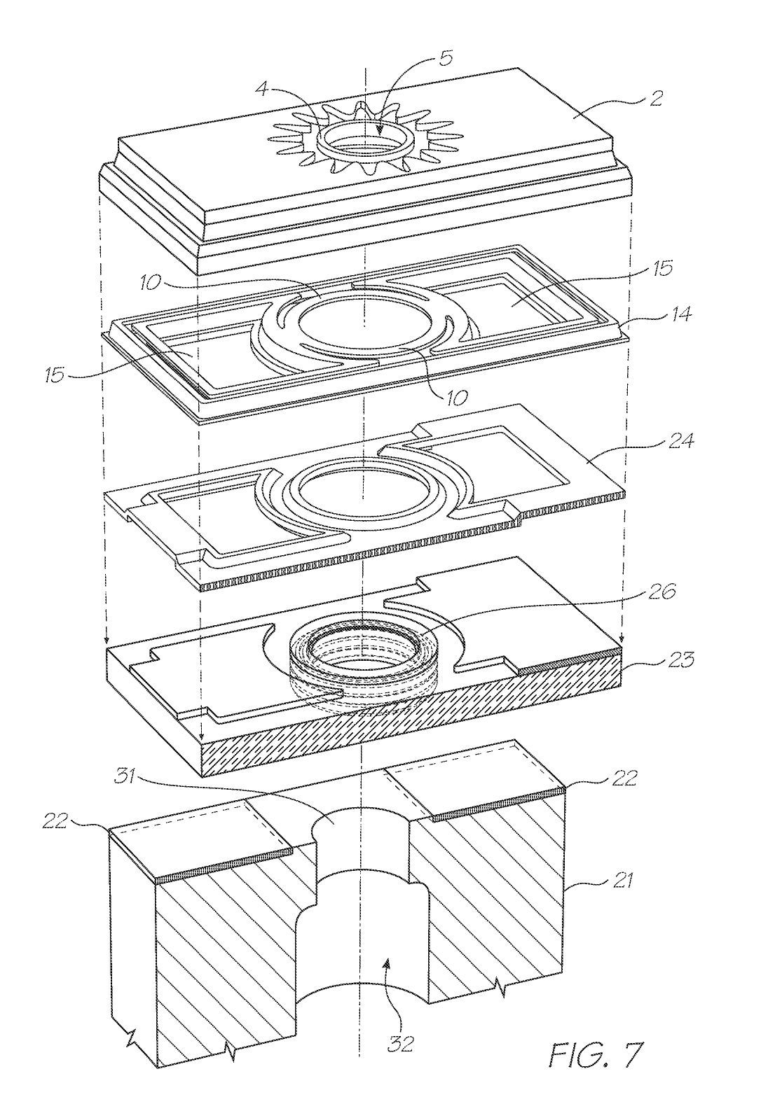

Referring to FIGS. 6 and 7, the unit cell 1 shown has the chamber 7, ink supply passage 32 and the nozzle rim 4 positioned mid way along the length of the unit cell 1. As best seen in FIG. 7, the drive circuitry 22 is partially on one side of the chamber 7 with the remainder on the opposing side of the chamber. The drive circuitry 22 controls the operation of the heater 14 through vias in the integrated circuit metallisation layers of the interconnect 23. The interconnect 23 has a raised metal layer on its top surface. Passivation layer 24 is formed in top of the interconnect 23 but leaves areas of the raised metal layer exposed. Electrodes 15 of the heater 14 contact the exposed metal areas to supply power to the element 10.

Alternatively, the drive circuitry 22 for one unit cell is not on opposing sides of the heater element that it controls. All the drive circuitry 22 for the heater 14 of one unit cell is in a single, undivided area that is offset from the heater. That is, the drive circuitry 22 is partially overlaid by one of the electrodes 15 of the heater 14 that it is controlling, and partially overlaid by one or more of the heater electrodes 15 from adjacent unit cells. In this situation, the center of the drive circuitry 22 is less than 200 microns from the center of the associate nozzle aperture 5. In most Memjet printheads of this type, the offset is less than 100 microns and in many cases less than 50 microns, preferably less than 30 microns.

Configuring the nozzle components so that there is significant overlap between the electrodes and the drive circuitry provides a compact design with high nozzle density (nozzles per unit area of the nozzle plate 2). This also improves the efficiency of the printhead by shortening the length of the conductors from the circuitry to the electrodes. The shorter conductors have less resistance and therefore dissipate less energy.

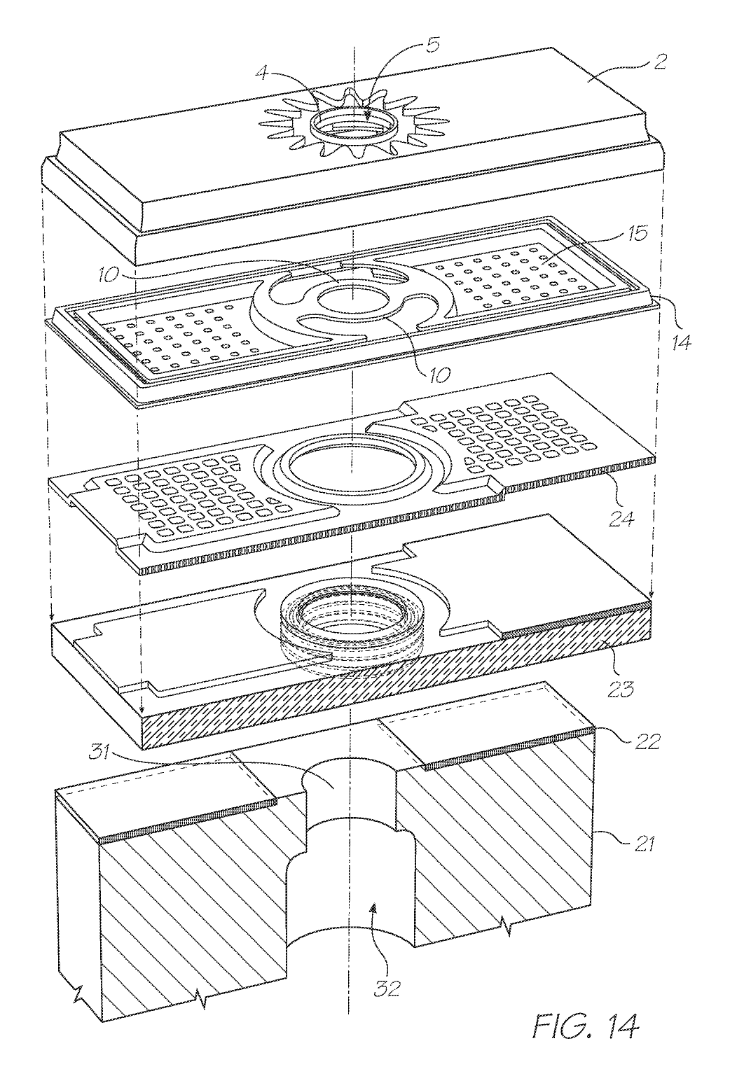

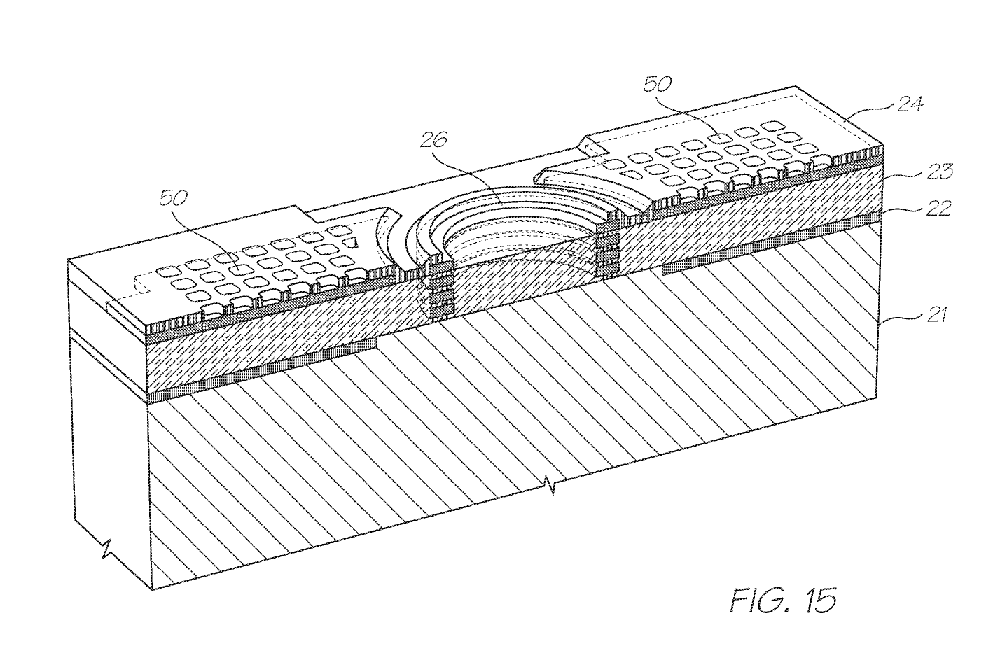

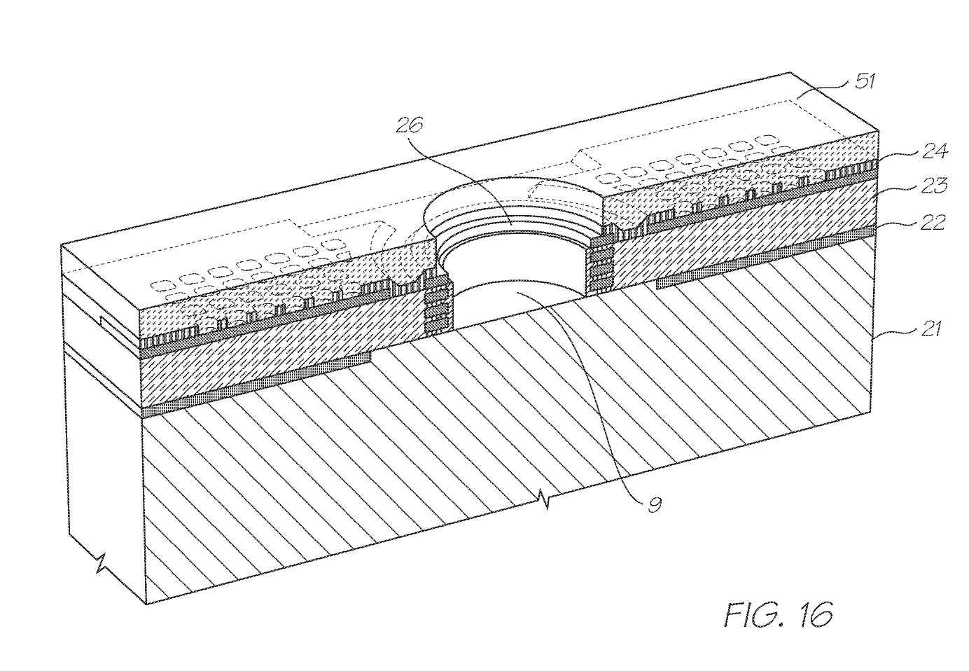

The high degree of overlap between the electrodes 15 and the drive circuitry 22 also allows more vias between the heater material and the CMOS metalization layers of the interconnect 23. As best shown in FIGS. 14 and 15, the passivation layer 24 has an array of vias to establish an electrical connection with the heater 14. More vias lowers the resistance between the heater electrodes 15 and the interconnect layer 23 which reduces power losses. However, the passivation layer 24 and electrodes 15 may also be provided without vias in order to simplify the fabrication process.

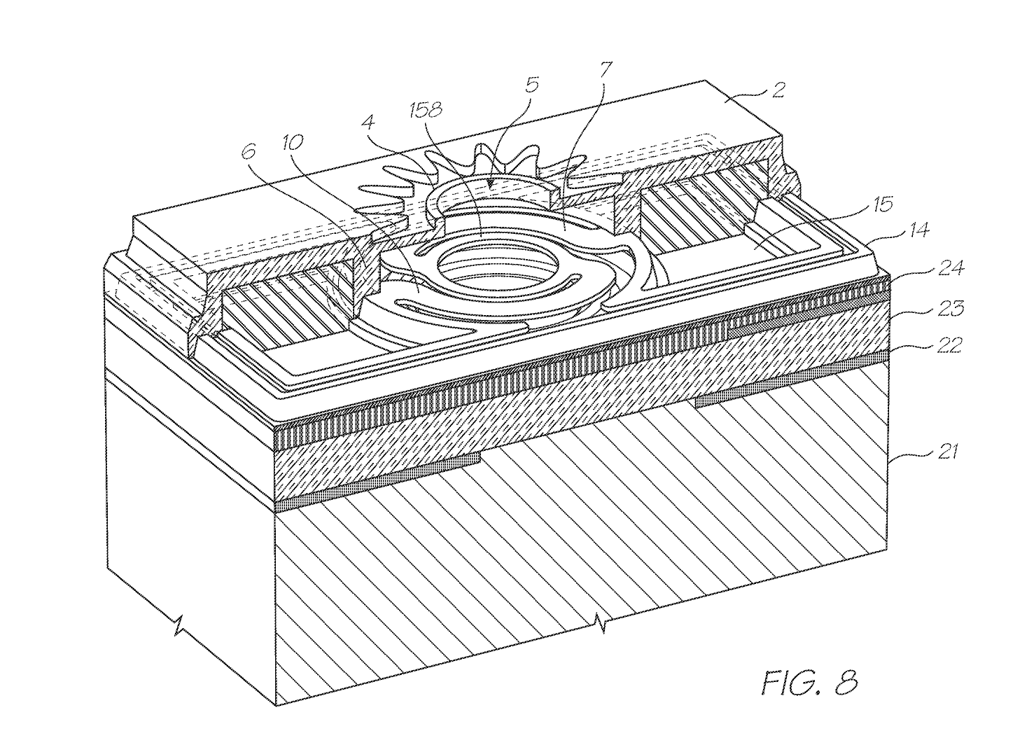

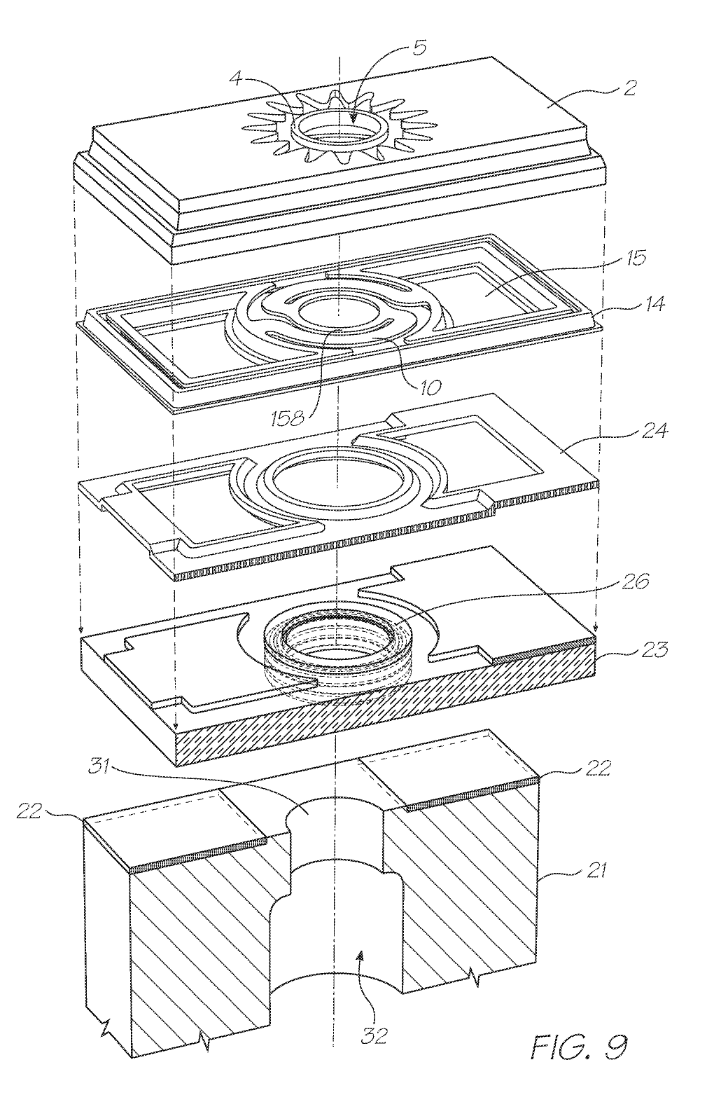

In FIGS. 8 and 9, the unit cell 1 is the same as that of FIGS. 6 and 7 apart from the heater element 10. The heater element 10 has a bubble nucleation section 158 with a smaller cross section than the remainder of the element. The bubble nucleation section 158 has a greater resistance and heats to a temperature above the boiling point of the ink before the remainder of the element 10. The gas bubble nucleates at this region and subsequently grows to surround the rest of the element 10. By controlling the bubble nucleation and growth, the trajectory of the ejected drop is more predictable.

The heater element 10 is configured to accommodate thermal expansion in a specific manner. As heater elements expand, they will deform to relieve the strain. Elements such as that shown in FIGS. 6 and 7 will bow out of the plane of lamination because its thickness is the thinnest cross sectional dimension and therefore has the least bending resistance. Repeated bending of the element can lead to the formation of cracks, especially at sharp corners, which can ultimately lead to failure. The heater element 10 shown in FIGS. 8 and 9 is configured so that the thermal expansion is relieved by rotation of the bubble nucleation section 158, and slightly splaying the sections leading to the electrodes 15, in preference to bowing out of the plane of lamination. The geometry of the element is such that miniscule bending within the plane of lamination is sufficient to relieve the strain of thermal expansion, and such bending occurs in preference to bowing. This gives the heater element greater longevity and reliability by minimizing bend regions, which are prone to oxidation and cracking.

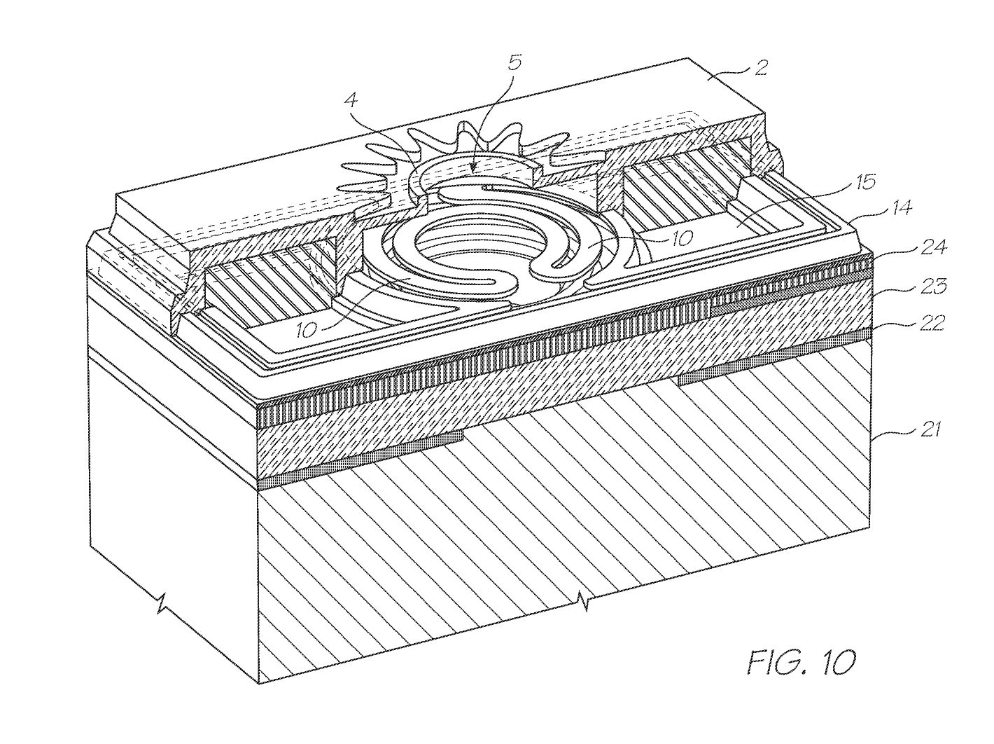

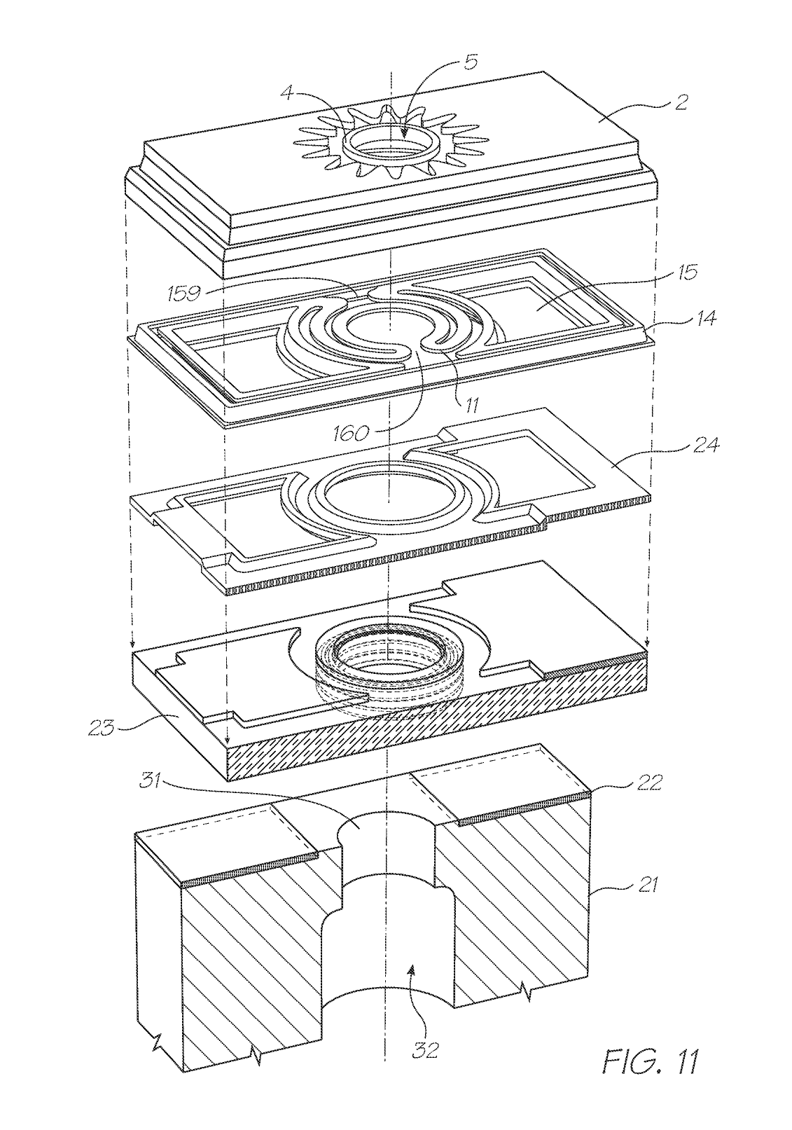

Referring to FIGS. 10 and 11, the heater element 10 used in this unit cell 1 has a serpentine or ‘double omega’ shape. This configuration keeps the gas bubble centered on the axis of the nozzle. A single omega is a simple geometric shape which is beneficial from a fabrication perspective. However the gap 159 between the ends of the heater element means that the heating of the ink in the chamber is slightly asymmetrical. As a result, the gas bubble is slightly skewed to the side opposite the gap 159. This can in turn affect the trajectory of the ejected drop. The double omega shape provides the heater element with the gap 160 to compensate for the gap 159 so that the symmetry and position of the bubble within the chamber is better controlled and the ejected drop trajectory is more reliable.

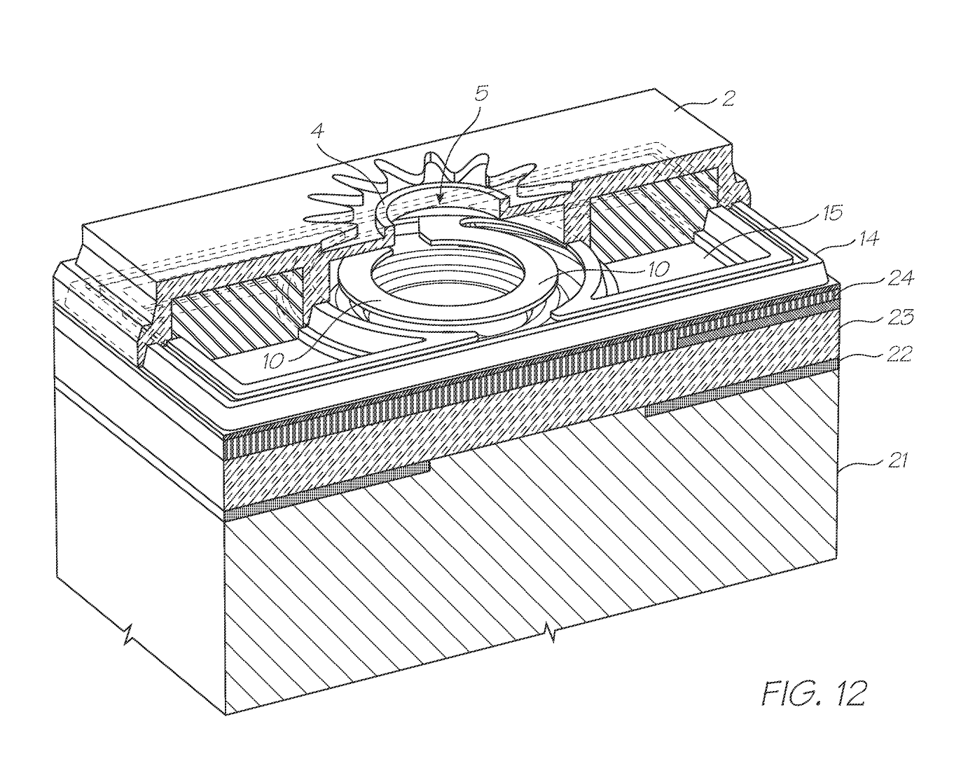

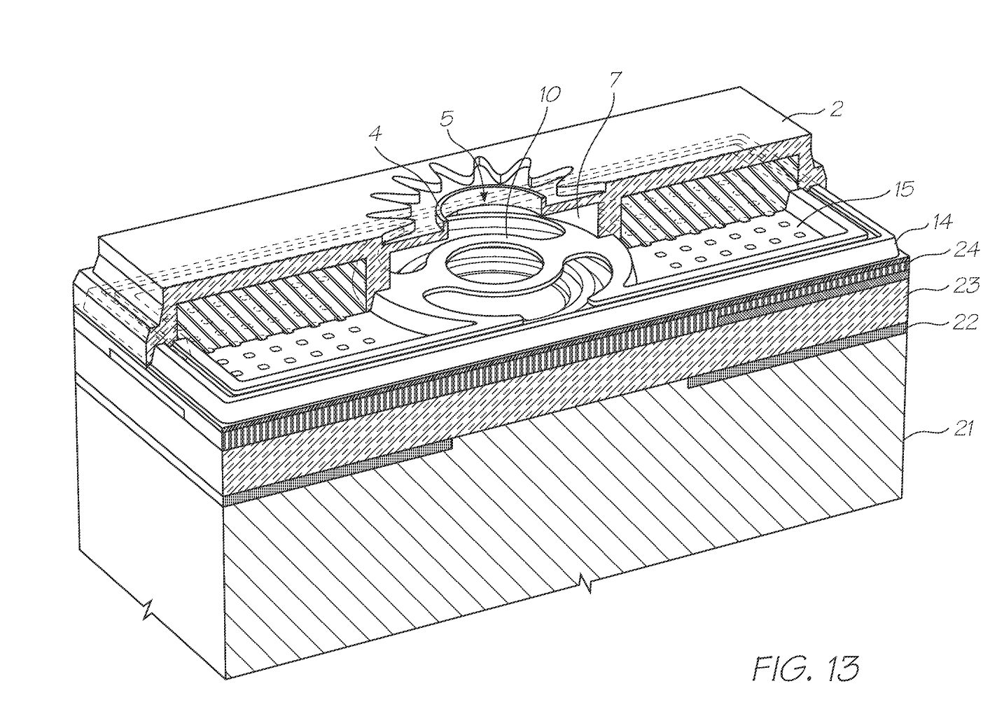

FIG. 12 shows a heater element 10 with a single omega shape. As discussed above, the simplicity of this shape has significant advantages during lithographic fabrication. It can be a single current path that is relatively wide and therefore less affected by any inherent inaccuracies in the deposition of the heater material. The inherent inaccuracies of the equipment used to deposit the heater material result in variations in the dimensions of the element. However, these tolerances are fixed values so the resulting variations in the dimensions of a relatively wide component are proportionally less than the variations for a thinner component. It will be appreciated that proportionally large changes of components dimensions will have a greater effect on their intended function. Therefore the performance characteristics of a relatively wide heater element are more reliable than a thinner one.

The omega shape directs current flow around the axis of the nozzle aperture 5. This gives good bubble alignment with the aperture for better ejection of drops while ensuring that the bubble collapse point is not on the heater element 10. As discussed above, this avoids problems caused by cavitation.

Referring to FIGS. 13 to 26, another embodiment of the unit cell 1 is shown together with several stages of the etching and deposition fabrication process. In this embodiment, the heater element 10 is suspended from opposing sides of the chamber. This allows it to be symmetrical about two planes that intersect along the axis of the nozzle aperture 5. This configuration provides a drop trajectory along the axis of the nozzle aperture 5 while avoiding the cavitation problems discussed above.

### Fabrication Process

In the interests of brevity, the fabrication stages have been shown for the unit cell of FIG. 13 only (see FIGS. 15 to 25). It will be appreciated that the other unit cells will use the same fabrication stages with different masking

Referring to FIG. 15, there is shown the starting point for fabrication of the thermal inkjet nozzle shown in FIG. 13. CMOS processing of a silicon wafer provides a silicon substrate 21 having drive circuitry 22, and an interlayer dielectric (“interconnect”) 23. The interconnect 23 comprises four metal layers, which together form a seal ring for the inlet passage 9 to be etched through the interconnect. The top metal layer 26, which forms an upper portion of the seal ring, can be seen in FIG. 15. The metal seal ring prevents ink moisture from seeping into the interconnect 23 when the inlet passage 9 is filled with ink.

A passivation layer 24 is deposited onto the top metal layer 26 by plasma-enhanced chemical vapour deposition (PECVD). After deposition of the passivation layer 24, it is etched to define a circular recess, which forms parts of the inlet passage 9. At the same as etching the recess, a plurality of vias 50 are also etched, which allow electrical connection through the passivation layer 24 to the top metal layer 26. The etch pattern is defined by a layer of patterned photoresist (not shown), which is removed by O₂ ashing after the etch.

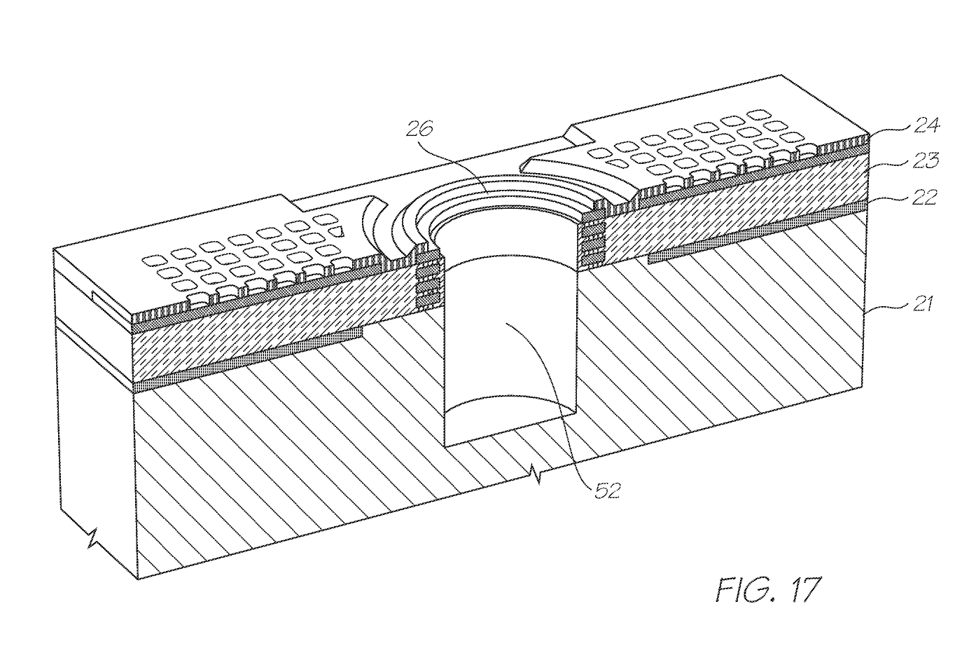

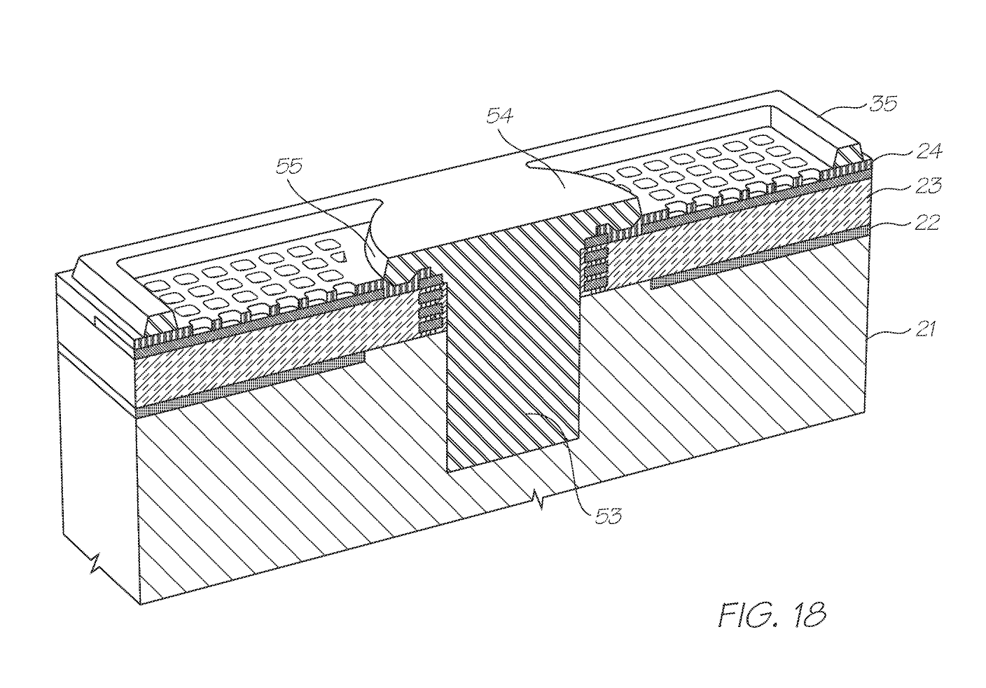

Referring to FIG. 16, in the next fabrication sequence, a layer of photoresist is spun onto the passivation later 24. The photoresist is exposed and developed to define a circular opening. With the patterned photoresist 51 in place, the dielectric interconnect 23 is etched as far as the silicon substrate 21 using a suitable oxide-etching gas chemistry (e.g. O₂/C₄F₈). Etching through the silicon substrate is continued down to about 20 microns to define a front ink hole 52, using a suitable silicon-etching gas chemistry (e.g. ‘Bosch etch’). The same photoresist mask 51 can be used for both etching steps. FIG. 17 shows the unit cell after etching the front ink hole 52 and removal of the photoresist 51.

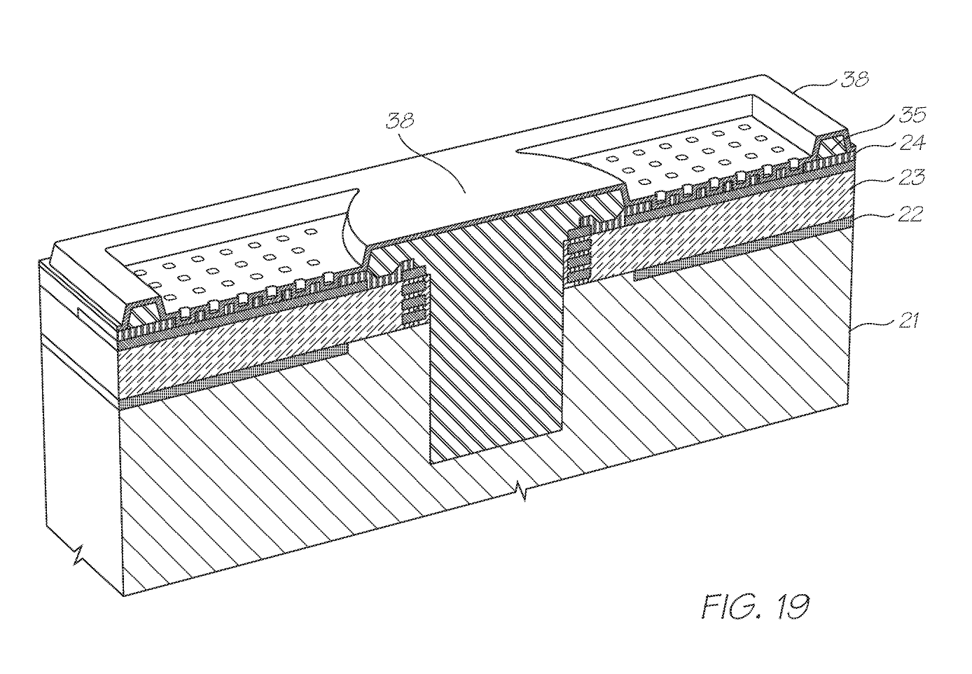

Referring to FIG. 18, in the next stage of fabrication, the front ink hole 52 is plugged with photoresist to provide a front plug 53. At the same time, a layer of photoresist is deposited over the passivation layer 24. This layer of photoresist is exposed and developed to define a first sacrificial scaffold 54 over the front plug 53, and scaffolding tracks 35 around the perimeter of the unit cell. The first sacrificial scaffold 54 is used for subsequent deposition of heater material 38 thereon and is therefore formed with a planar upper surface to avoid any buckling in the heater element (see heater element 10 in FIG. 13). The first sacrificial scaffold 54 is UV cured and hardbaked to prevent reflow of the photoresist during subsequent high-temperature deposition onto its upper surface.

Importantly, the first sacrificial scaffold 54 has sloped or angled side faces 55. These angled side faces 55 are formed by adjusting the focusing in the exposure tool (e.g. stepper) when exposing the photoresist. The sloped side faces 55 advantageously allow heater material 38 to be deposited substantially evenly over the first sacrificial scaffold 54.

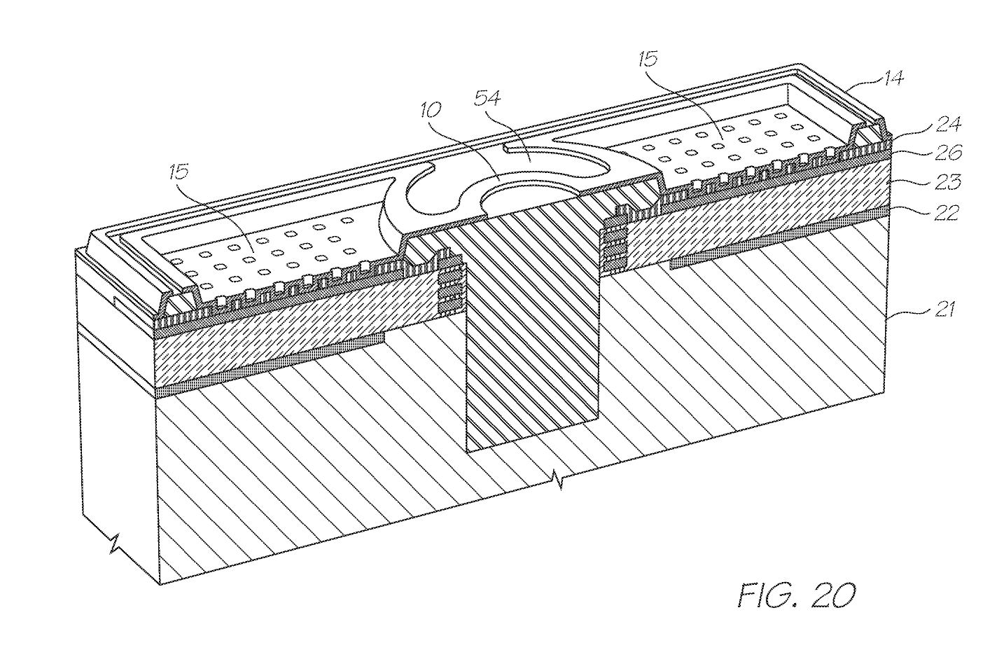

Referring to FIG. 19, the next stage of fabrication deposits the heater material 38 over the first sacrificial scaffold 54, the passivation layer 24 and the perimeter scaffolding tracks 35. The heater material 38 is typically a monolayer of TiAlN. However, the heater material 38 may alternatively comprise TiAlN sandwiched between upper and lower passivating materials, such as tantalum or tantalum nitride. Passivating layers on the heater element 10 minimize corrosion of the and improve heater longevity.

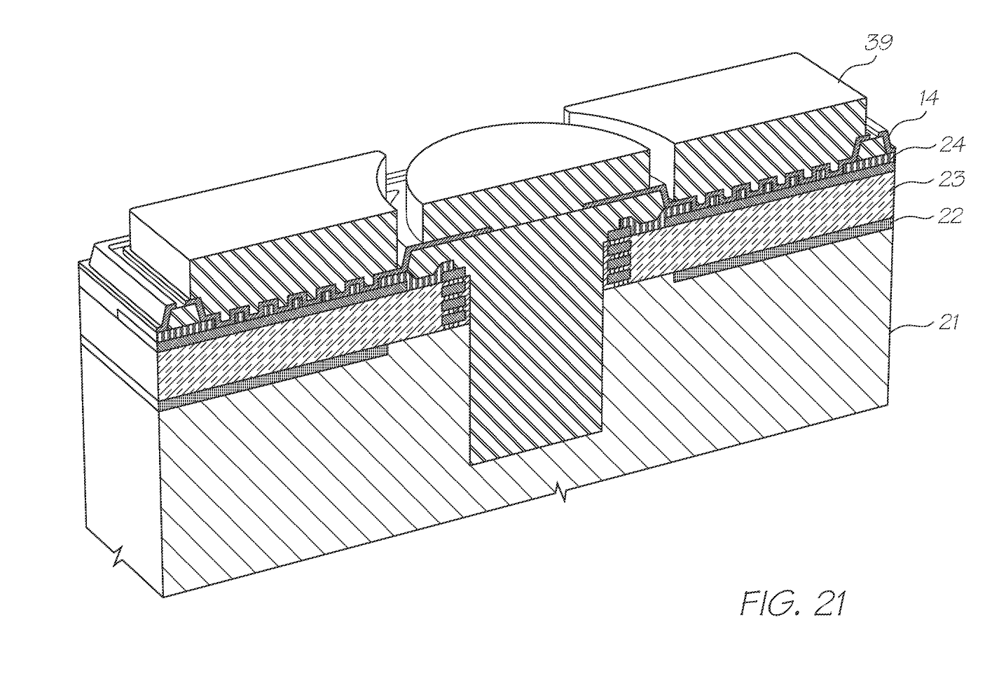

Referring to FIG. 20, the heater material 38 is subsequently etched down to the first sacrificial scaffold 54 to define the heater element 10. At the same time, contact electrodes 15 are defined on either side of the heater element 10. The electrodes 15 are in contact with the top metal layer 26 and so provide electrical connection between the CMOS and the heater element 10. The sloped side faces of the first sacrificial scaffold 54 ensure good electrical connection between the heater element 10 and the electrodes 15, since the heater material is deposited with sufficient thickness around the scaffold 54. Any thin areas of heater material (due to insufficient side face deposition) would increase resistivity and affect heater performance.

Adjacent unit cells are electrically insulated from each other by virtue of grooves etched around the perimeter of each unit cell. The grooves are etched at the same time as defining the heater element 10.

Referring to FIG. 21, in the subsequent step a second sacrificial scaffold 39 of photoresist is deposited over the heater material. The second sacrificial scaffold 39 is exposed and developed to define sidewalls for the cylindrical nozzle chamber and perimeter sidewalls for each unit cell. The second sacrificial scaffold 39 is also UV cured and hardbaked to prevent any reflow of the photoresist during subsequent high-temperature deposition of the silicon nitride roof material.

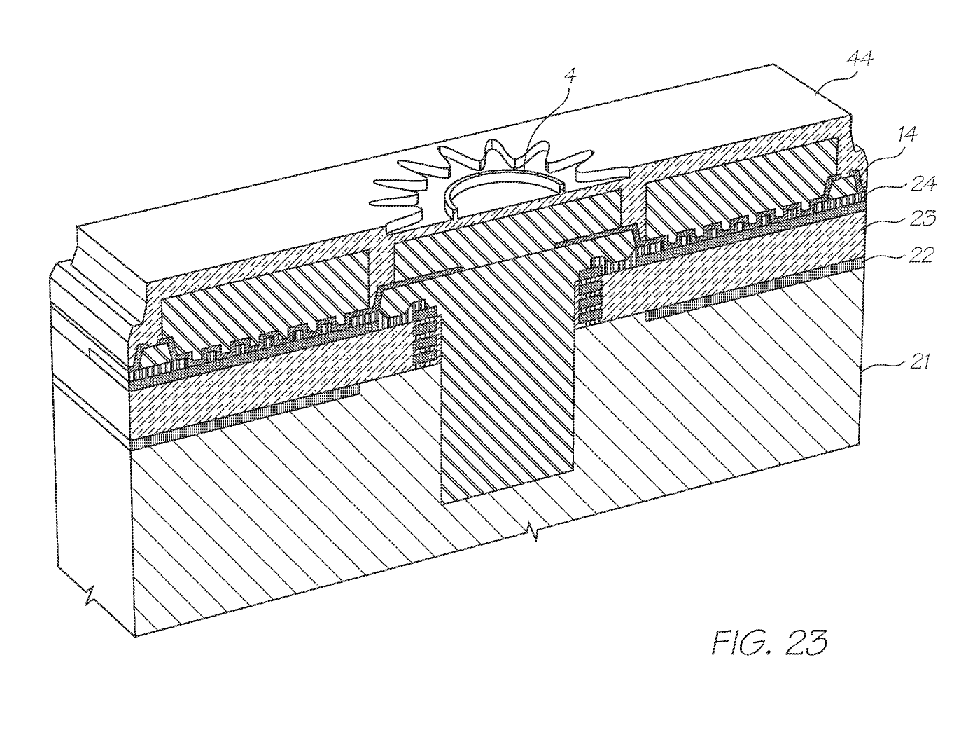

Referring to FIG. 22, silicon nitride is deposited onto the second sacrificial scaffold 39 by plasma enhanced chemical vapour deposition. The silicon nitride forms a roof 44 over each unit cell, which is the nozzle plate 2 for a row of nozzles. Chamber sidewalls 6 and unit cell sidewalls 56 are also formed by deposition of silicon nitride.

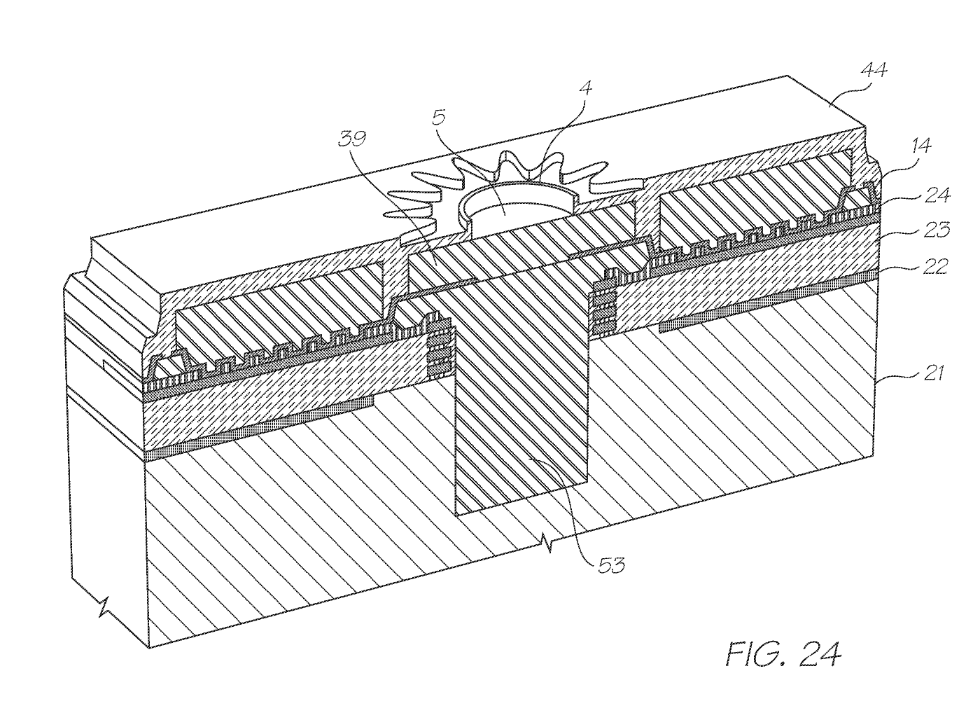

Referring to FIG. 23, the nozzle rim 4 is etched partially through the roof 44, by placing a suitably patterned photoresist mask over the roof, etching for a controlled period of time and removing the photoresist by ashing.

Referring to FIG. 24, the nozzle aperture 5 is etched through the roof 24 down to the second sacrificial scaffold 39. Again, the etch is performed by placing a suitably patterned photoresist mask over the roof, etching down to the scaffold 39 and removing the photoresist mask.

With the nozzle structure now fully formed on a frontside of the silicon substrate 21, an ink supply channel 32 is etched from the backside of the substrate 21, which meets with the front plug 53.

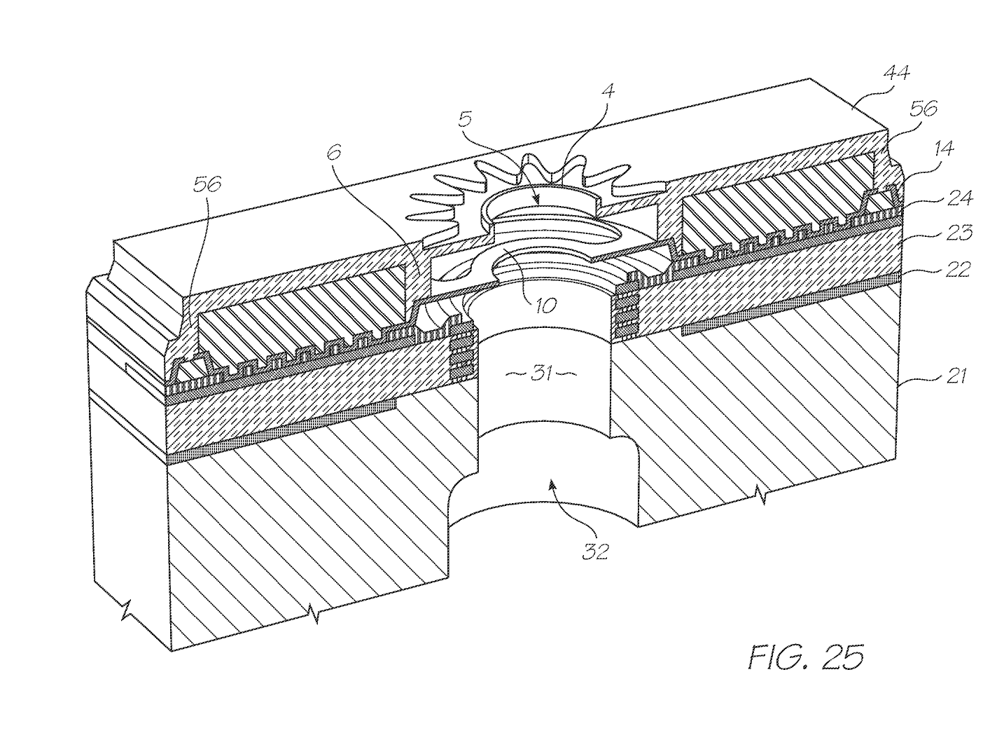

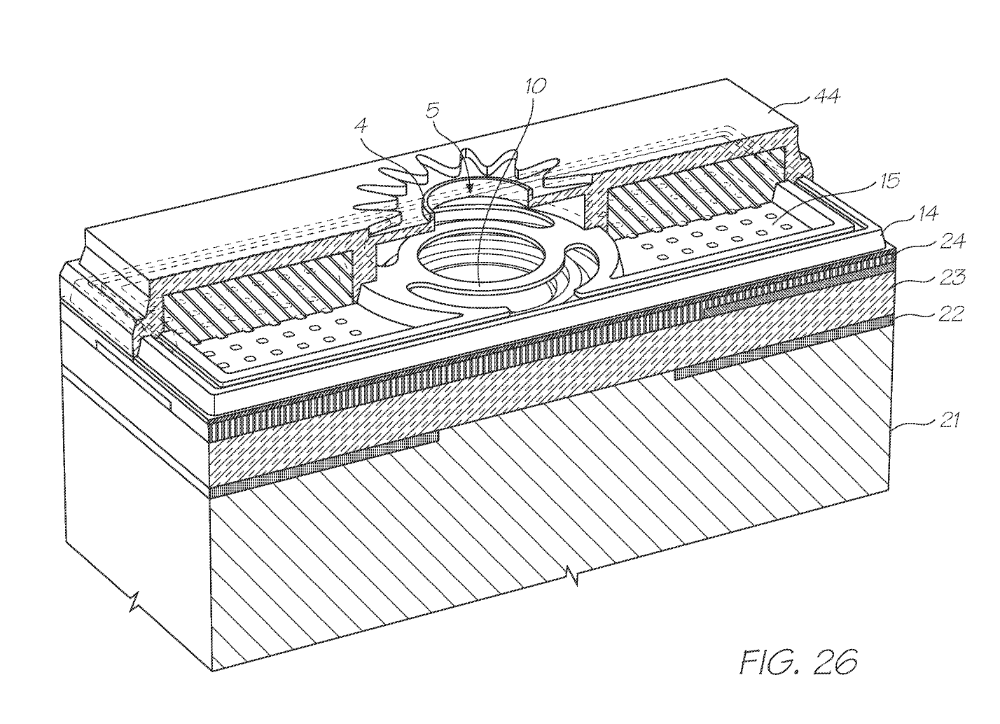

Referring to FIG. 25, after formation of the ink supply channel 32, the first and second sacrificial scaffolds of photoresist, together with the front plug 53 are ashed off using an O₂ plasma. Accordingly, fluid connection is made from the ink supply channel 32 through to the nozzle aperture 5.

It should be noted that a portion of photoresist, on either side of the nozzle chamber sidewalls 6, remains encapsulated by the roof 44, the unit cell sidewalls 56 and the chamber sidewalls 6. This portion of photoresist is sealed from the O₂ ashing plasma and, therefore, remains intact after fabrication of the printhead. This encapsulated photoresist advantageously provides additional robustness for the printhead by supporting the nozzle plate 2. Hence, the printhead has a robust nozzle plate spanning continuously over rows of nozzles, and being supported by solid blocks of hardened photoresist, in addition to support walls.

### Hydrophobic Coating of Front Face

Referring to FIG. 24, it can been seen that a hydrophobic material may be deposited onto the roof 44 at this stage by, for example, chemical vapour deposition. The whole of the front face of the printhead may be coated with hydrophobic material. Alternatively, predetermined regions of the roof 44 (e.g. regions surrounding each nozzle aperture 5) may be coated. However, referring to FIG. 25, the final stage of printhead fabrication involves ashing off the photoresist, which occupies the nozzle chambers. Since hydrophobic coating materials are generally organic in nature, the ashing process will remove the hydrophobic coating on the roof 44 as well as the photoresist 39 in the nozzle chambers. Hence, a hydrophobic coating step at this stage would ultimately have no effect on the hydrophobicity of the roof 44.

Referring to FIG. 25, it can be seen that a hydrophobic material may be deposited onto the roof 44 at this stage by, for example, chemical vapour deposition. However, the CVD process will deposit the hydrophobic material both onto the roof 44, onto nozzle chamber sidewalls, onto the heater element 10 and inside ink supply channels 32. A hydrophobic coating inside the nozzle chambers and ink supply channels would be highly undesirable in terms of creating a positive ink pressure biased towards the nozzle chambers. A hydrophobic coating on the heater element 10 would be equally undesirable in terms of kogation during printing.

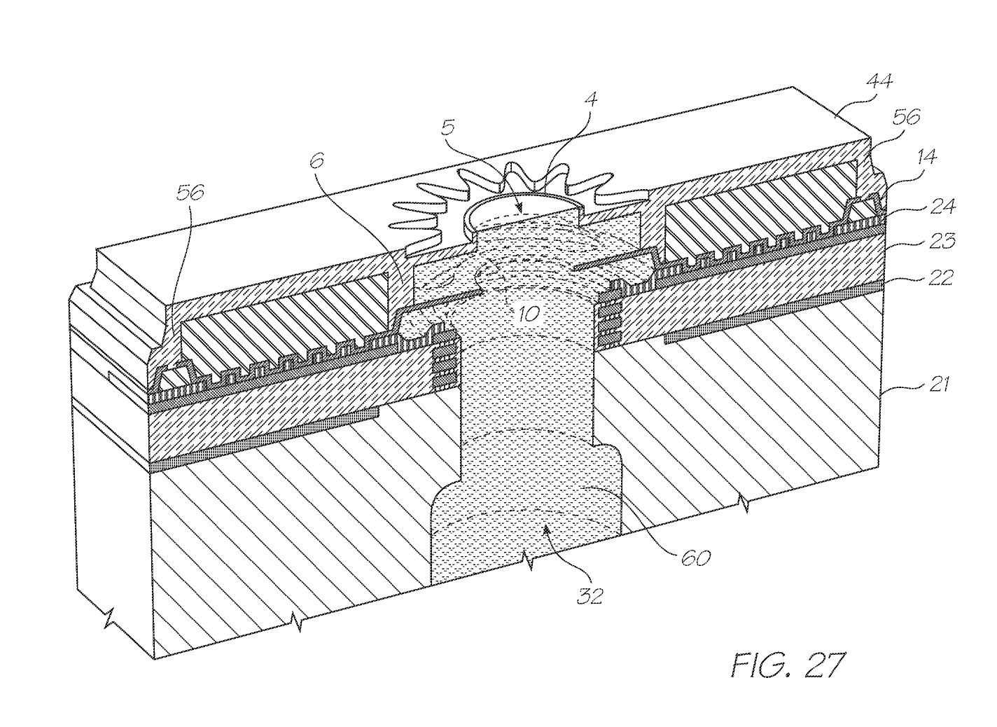

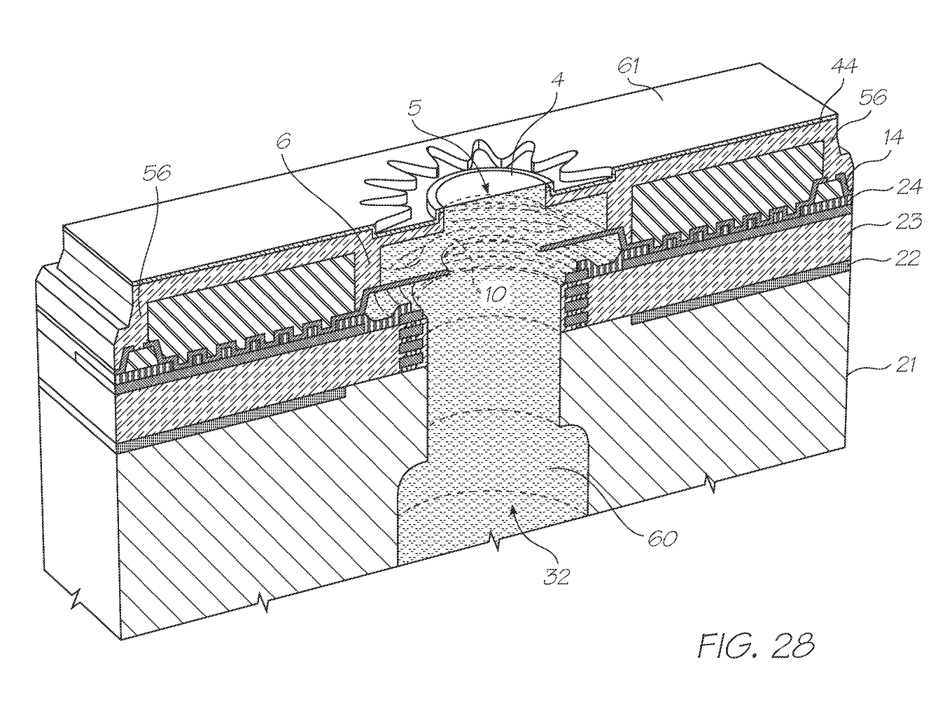

Referring to FIG. 27, there is shown a process for depositing a hydrophobic material onto the roof 44, which eliminates the aforementioned selectivity problems. Before deposition of the hydrophobic material, the printhead is primed with a liquid, which fills the ink supply channels 32 and nozzle chamber up to the rim 4. The liquid is preferably ink so that the hydrophobic deposition step can be incorporated into the overall printer manufacturing process. Once primed with ink 60, the front face of the printhead, including the roof 44, is coated with a hydrophobic material 61 by chemical vapour deposition (see FIG. 28). The hydrophobic material 61 cannot be deposited inside the nozzle chamber, because the ink 60 effectively seals the nozzle aperture 5 from the vapour. Hence, the ink 60 protects the nozzle chamber and allows selective deposition of the hydrophobic material 61 onto the roof 44. Accordingly, the final printhead has a hydrophobic front face in combination with hydrophilic nozzle chambers and ink supply channels.

The choice of hydrophobic material is not critical. Any hydrophobic compound, which can adhere to the roof 44 by either covalent bonding, ionic bonding, chemisorption or adsorption may be used. The choice of hydrophobic material will depend on the material forming the roof 44 and also the liquid used to prime the nozzles.

Typically, the roof 44 is formed from silicon nitride, silicon oxide or silicon oxynitride. In this case, the hydrophobic material is typically a compound, which can form covalent bonds with the oxygen or nitrogen atoms exposed on the surface of the roof. Examples of suitable compounds are silyl chlorides (including monochlorides, dichlorides, trichlorides) having at least one hydrophobic group. The hydrophobic group is typically a C₁₋₂₀ alkyl group, optionally substituted with a plurality of fluorine atoms. The hydrophobic group may be perfluorinated, partially fluorinated or non-fluorinated. Examples of suitable hydrophobic compounds include: trimethylsilyl chloride, dimethylsilyl dichloride, methylsilyl trichloride, triethylsilyl chloride, octyldimethylsilyl chloride, perfluorooctyldimethylsilyl chloride, perfluorooctylsilyl trichloride, perfluorooctylchlorosilane etc.

Typically, the nozzles are primed with an inkjet ink. In this case, the hydrophobic material is typically a compound, which does not polymerise in aqueous solution and form a skin across the nozzle aperture 5. Examples of non-polymerizable hydrophobic compounds include: trimethylsilyl chloride, triethylsilyl chloride, perfluorooctyldimethylsilyl chloride, perfluorooctylchlorosilane etc.

Whilst silyl chlorides have been exemplified as hydrophobizing compounds hereinabove, it will be appreciated that the present invention may be used in conjunction with any hydrophobizing compound, which can be deposited by CVD or another suitable deposition process.

### Other Embodiments

The invention has been described above with reference to printheads using bubble forming heater elements. However, it is potentially suited to a wide range of printing system including: color and monochrome office printers, short run digital printers, high speed digital printers, offset press supplemental printers, low cost scanning printers high speed pagewidth printers, notebook computers with inbuilt pagewidth printers, portable color and monochrome printers, color and monochrome copiers, color and monochrome facsimile machines, combined printer, facsimile and copying machines, label printers, large format plotters, photograph copiers, printers for digital photographic “minilabs”, video printers, PHOTO CD (PHOTO CD is a registered trade mark of the Eastman Kodak Company) printers, portable printers for PDAs, wallpaper printers, indoor sign printers, billboard printers, fabric printers, camera printers and fault tolerant commercial printer arrays.

It will be appreciated by ordinary workers in this field that numerous variations and/or modifications may be made to the present invention as shown in the specific embodiments without departing from the spirit or scope of the invention as broadly described. The present embodiments are, therefore, to be considered in all respects to be illustrative and not restrictive.

### Ink Jet Technologies

The embodiments of the invention use an ink jet printer type device. Of course many different devices could be used.

The most significant problem with thermal ink jet is power consumption. This is approximately 100 times that required for high speed, and stems from the energy-inefficient means of drop ejection. This involves the rapid boiling of water to produce a vapor bubble which expels the ink. Water has a very high heat capacity, and must be superheated in thermal ink jet applications. In conventional thermal inkjet printheads, this leads to an efficiency of around 0.02%, from electricity input to drop momentum (and increased surface area) out.

The most significant problem with piezoelectric ink jet is size and cost. Piezoelectric crystals have a very small deflection at reasonable drive voltages, and therefore require a large area for each nozzle. Also, each piezoelectric actuator must be connected to its drive circuit on a separate substrate. This is not a significant problem at the current limit of around 300 nozzles per printhead, but is a major impediment to the fabrication of pagewidth printheads with 19,200 nozzles.

Ideally, the ink jet technologies used meet the stringent requirements of in-camera digital color printing and other high quality, high speed, low cost printing applications. To meet the requirements of digital photography, new ink jet technologies have been created. The target features include:

low power (less than 10 Watts)

high resolution capability (1,600 dpi or more)

photographic quality output

low manufacturing cost

small size (pagewidth times minimum cross section)

high speed (<2 seconds per page).

All of these features can be met or exceeded by the ink jet systems described below with differing levels of difficulty. Forty-five different ink jet technologies have been developed by the Assignee to give a wide range of choices for high volume manufacture. These technologies form part of separate applications assigned to the present Assignee as set out in the table under the heading Cross References to Related Applications.

The ink jet designs shown here are suitable for a wide range of digital printing systems, from battery powered one-time use digital cameras, through to desktop and network printers, and through to commercial printing systems.

For ease of manufacture using standard process equipment, the printhead is designed to be a monolithic 0.5 micron CMOS chip with MEMS post processing. For color photographic applications, the printhead is 100 mm long, with a width which depends upon the ink jet type. The smallest printhead designed is IJ38, which is 0.35 mm wide, giving a chip area of 35 square mm. The printheads each contain 19,200 nozzles plus data and control circuitry.

Ink is supplied to the back of the printhead by injection molded plastic ink channels. The molding requires 50 micron features, which can be created using a lithographically micromachined insert in a standard injection molding tool Ink flows through holes etched through the wafer to the nozzle chambers fabricated on the front surface of the wafer. The printhead is connected to the camera circuitry by tape automated bonding.

### Tables of Drop-on-Demand Ink Jets

Eleven important characteristics of the fundamental operation of individual ink jet nozzles have been identified. These characteristics are largely orthogonal, and so can be elucidated as an eleven dimensional matrix. Most of the eleven axes of this matrix include entries developed by the present assignee.

The following tables form the axes of an eleven dimensional table of ink jet types.

Actuator mechanism (18 types)

Basic operation mode (7 types)

Auxiliary mechanism (8 types)

Actuator amplification or modification method (17 types)

Actuator motion (19 types)

Nozzle refill method (4 types)

Method of restricting back-flow through inlet (10 types)

Nozzle clearing method (9 types)

Nozzle plate construction (9 types)

Drop ejection direction (5 types)

Ink type (7 types)

The complete eleven dimensional table represented by these axes contains 36.9 billion possible configurations of ink jet nozzle. While not all of the possible combinations result in a viable ink jet technology, many million configurations are viable. It is clearly impractical to elucidate all of the possible configurations. Instead, certain ink jet types have been investigated in detail. These are designated IJ01 to IJ45 above which matches the docket numbers in the table under the heading Cross References to Related Applications.

Other ink jet configurations can readily be derived from these forty-five examples by substituting alternative configurations along one or more of the 11 axes. Most of the IJ01 to IJ45 examples can be made into ink jet printheads with characteristics superior to any currently available ink jet technology.

Where there are prior art examples known to the inventor, one or more of these examples are listed in the examples column of the tables below. The IJ01 to IJ45 series are also listed in the examples column. In some cases, print technology may be listed more than once in a table, where it shares characteristics with more than one entry.

Suitable applications for the ink jet technologies include: Home printers, Office network printers, Short run digital printers, Commercial print systems, Fabric printers, Pocket printers, Internet WWW printers, Video printers, Medical imaging, Wide format printers, Notebook PC printers, Fax machines, Industrial printing systems, Photocopiers, Photographic minilabs etc.

The information associated with the aforementioned 11 dimensional matrix are set out in the following tables.

ACTUATOR MECHANISM (APPLIED ONLY TO SELECTED INK DROPS)

| | Description | Advantages | Disadvantages | Examples |
|---|---|---|---|---|
| Thermal | An electrothermal | Large force | High power | Canon Bubblejet |
| bubble | heater heats the ink to | generated | Ink carrier | 1979 Endo et al GB |
| | above boiling point, | Simple | limited to water | patent 2,007,162 |
| | transferring significant | construction | Low efficiency | Xerox heater-in- |
| | heat to the aqueous | No moving parts | High | pit 1990 Hawkins et |
| | ink. A bubble | Fast operation | temperatures | al U.S. Pat. No. |
| | nucleates and quickly | Small chip area | required | 4,899,181 |
| | forms, expelling the | required for actuator | High mechanical | Hewlett-Packard |
| | ink. | | stress | TIJ 1982 Vaught et |
| | The efficiency of the | | Unusual | al U.S. Pat. No. |
| | process is low, with | | materials required | 4,490,728 |
| | typically less than | | Large drive | |
| | 0.05% of the electrical | | transistors | |
| | energy being | | Cavitation causes | |
| | transformed into | | actuator failure | |
| | kinetic energy of the | | Kogation reduces | |
| | drop. | | bubble formation | |
| | | | Large print heads | |
| | | | are difficult to | |
| | | | fabricate | |
| Piezo- | A piezoelectric crystal | Low power | Very large area | Kyser et al |
| electric | such as lead | consumption | required for actuator | U.S. Pat. No. 3,946,398 |
| | lanthanum zirconate | Many ink types | Difficult to | Zoltan U.S. Pat. |
| | (PZT) is electrically | can be used | integrate with | No. 3,683,212 |
| | activated, and either | Fast operation | electronics | 1973 Stemme |
| | expands, shears, or | High efficiency | High voltage | U.S. Pat. No. 3,747,120 |
| | bends to apply | | drive transistors | Epson Stylus |
| | pressure to the ink, | | required | Tektronix |
| | ejecting drops. | | Full pagewidth | IJ04 |
| | | | print heads | |
| | | | impractical due to | |
| | | | actuator size | |
| | | | Requires | |
| | | | electrical poling in | |
| | | | high field strengths | |
| | | | during manufacture | |
| Electro- | An electric field is | Low power | Low maximum | Seiko Epson, |
| strictive | used to activate | consumption | strain (approx. | Usui et all JP |
| | electrostriction in | Many ink types | 0.01%) | 253401/96 |
| | relaxor materials such | can be used | Large area | IJ04 |
| | as lead lanthanum | Low thermal | required for actuator | |
| | zirconate titanate | expansion | due to low strain | |
| | (PLZT) or lead | Electric field | Response speed | |
| | magnesium niobate | strength required | is marginal (~10 | |
| | (PMN). | (approx. 3.5 | μs) | |
| | | V/μm) | High voltage | |
| | | can be generated | drive transistors | |
| | | without difficulty | required | |
| | | Does not require | Full pagewidth | |
| | | electrical poling | print heads | |
| | | | impractical due to | |
| | | | actuator size | |
| Ferro- | An electric field is | Low power | Difficult to | IJ04 |
| electric | used to induce a phase | consumption | integrate with | |
| | transition between the | Many ink types | electronics | |
| | antiferroelectric (AFE) | can be used | Unusual | |
| | and ferroelectric (FE) | Fast operation | materials such as | |
| | phase. Perovskite | (<1 μs) | PLZSnT are | |
| | materials such as tin | Relatively high | required | |
| | modified lead | longitudinal strain | Actuators require | |
| | lanthanum zirconate | High efficiency | a large area | |
| | titanate (PLZSnT) | Electric field | | |
| | exhibit large strains of | strength of around 3 | | |
| | up to 1% associated | V/μm can be | | |
| | with the AFE to FE | readily provided | | |
| | phase transition. | | | |
| Electro- | Conductive plates are | Low power | Difficult to | IJ02, IJ04 |
| static plates | separated by a | consumption | operate electrostatic | |
| | compressible or fluid | Many ink types | devices in an | |
| | dielectric (usually air). | can be used | aqueous | |
| | Upon application of a | Fast operation | environment | |
| | voltage, the plates | | The electrostatic | |
| | attract each other and | | actuator will | |
| | displace ink, causing | | normally need to be | |
| | drop ejection. The | | separated from the | |
| | conductive plates may | | ink | |
| | be in a comb or | | Very large area | |
| | honeycomb structure, | | required to achieve | |
| | or stacked to increase | | high forces | |
| | the surface area and | | High voltage | |
| | therefore the force. | | drive transistors | |
| | | | may be required | |
| | | | Full pagewidth | |
| | | | print heads are not | |
| | | | competitive due to | |
| | | | actuator size | |
| Electro- | A strong electric field | Low current | High voltage | 1989 Saito et al, |
| static pull | is applied to the ink, | consumption | required | U.S. Pat. No. 4,799,068 |
| on ink | whereupon | Low temperature | May be damaged | 1989 Miura et al, |
| | electrostatic attraction | | by sparks due to air | U.S. Pat. No. 4,810,954 |
| | accelerates the ink | | breakdown | Tone-jet |
| | towards the print | | Required field | |
| | medium. | | strength increases as | |
| | | | the drop size | |
| | | | decreases | |
| | | | High voltage | |
| | | | drive transistors | |
| | | | required | |
| | | | Electrostatic field | |
| | | | attracts dust | |
| Permanent | An electromagnet | Low power | Complex | IJ07, IJ10 |
| magnet | directly attracts a | consumption | fabrication | |
| electro- | permanent magnet, | Many ink types | Permanent | |
| magnetic | displacing ink and | can be used | magnetic material | |
| | causing drop ejection. | Fast operation | such as Neodymium | |
| | Rare earth magnets | High efficiency | Iron Boron (NdFeB) | |
| | with a field strength | Easy extension | required. | |
| | around 1 Tesla can be | from single nozzles | High local | |
| | used. Examples are: | to pagewidth print | currents required | |
| | Samarium Cobalt | heads | Copper | |
| | (SaCo) and magnetic | | metalization should | |
| | materials in the | | be used for long | |
| | neodymium iron boron | | electromigration | |
| | family (NdFeB, | | lifetime and low | |
| | NdDyFeBNb, | | resistivity | |
| | NdDyFeB, etc) | | Pigmented inks | |
| | | | are usually | |
| | | | infeasible | |
| | | | Operating | |
| | | | temperature limited | |
| | | | to the Curie | |
| | | | temperature (around | |
| | | | 540K) | |
| Soft | A solenoid induced a | Low power | Complex | IJ01, IJ05, IJ08, IJ10 |
| magnetic | magnetic field in a soft | consumption | fabrication | IJ12, IJ14, IJ15, IJ17 |
| core electro- | magnetic core or yoke | Many ink types | Materials not | |
| magnetic | fabricated from a | can be used | usually present in a | |
| | ferrous material such | Fast operation | CMOS fab such as | |
| | as electroplated iron | High efficiency | NiFe, CoNiFe, or | |
| | alloys such as CoNiFe | Easy extension | CoFe are required | |
| | [1], CoFe, or NiFe | from single nozzles | High local | |
| | alloys. Typically, the | to pagewidth print | currents required | |
| | soft magnetic material | heads | Copper | |
| | is in two parts, which | | metalization should | |
| | are normally held | | be used for long | |
| | apart by a spring. | | electromigration | |
| | When the solenoid is | | lifetime and low | |
| | actuated, the two parts | | resistivity | |
| | attract, displacing the | | Electroplating is | |
| | ink. | | required | |
| | | | High saturation | |
| | | | flux density is | |
| | | | required (2.0-2.1 T | |
| | | | is achievable with | |
| | | | CoNiFe [1]) | |
| Lorenz | The Lorenz force | Low power | Force acts as a | IJ06, IJ11, IJ13, IJ16 |
| force | acting on a current | consumption | twisting motion | |
| | carrying wire in a | Many ink types | Typically, only a | |
| | magnetic field is | can be used | quarter of the | |
| | utilized. | Fast operation | solenoid length | |
| | This allows the | High efficiency | provides force in a | |
| | magnetic field to be | Easy extension | useful direction | |
| | supplied externally to | from single nozzles | High local | |
| | the print head, for | to pagewidth print | currents required | |
| | example with rare | heads | Copper | |
| | earth permanent | | metalization should | |
| | magnets. | | be used for long | |
| | Only the current | | electromigration | |
| | carrying wire need be | | lifetime and low | |
| | fabricated on the print- | | resistivity | |
| | head, simplifying | | Pigmented inks | |
| | materials | | are usually | |
| | requirements. | | infeasible | |
| Magneto- | The actuator uses the | Many ink types | Force acts as a | Fischenbeck, |
| striction | giant magnetostrictive | can be used | twisting motion | U.S. Pat. No. 4,032,929 |
| | effect of materials | Fast operation | Unusual | IJ25 |
| | such as Terfenol-D (an | Easy extension | materials such as | |
| | alloy of terbium, | from single nozzles | Terfenol-D are | |
| | dysprosium and iron | to pagewidth print | required | |
| | developed at the Naval | heads | High local | |
| | Ordnance Laboratory, | High force is | currents required | |
| | hence Ter-Fe-NOL). | available | Copper | |
| | For best efficiency, the | | metalization should | |
| | actuator should be pre- | | be used for long | |
| | stressed to approx. 8 | | electromigration | |
| | MPa. | | lifetime and low | |
| | | | resistivity | |
| | | | Pre-stressing | |
| | | | may be required | |
| Surface | Ink under positive | Low power | Requires | Silverbrook, EP |
| tension | pressure is held in a | consumption | supplementary force | 0771 658 A2 and |
| reduction | nozzle by surface | Simple | to effect drop | related patent |
| | tension. The surface | construction | separation | applications |
| | tension of the ink is | No unusual | Requires special | |
| | reduced below the | materials required in | ink surfactants | |
| | bubble threshold, | fabrication | Speed may be | |
| | causing the ink to | High efficiency | limited by surfactant | |
| | egress from the | Easy extension | properties | |
| | nozzle. | from single nozzles | | |
| | | to pagewidth print | | |
| | | heads | | |
| Viscosity | The ink viscosity is | Simple | Requires | Silverbrook, EP |
| reduction | locally reduced to | construction | supplementary force | 0771 658 A2 and |
| | select which drops are | No unusual | to effect drop | related patent |
| | to be ejected. A | materials required in | separation | applications |
| | viscosity reduction can | fabrication | Requires special | |
| | be achieved | Easy extension | ink viscosity | |
| | electrothermally with | from single nozzles | properties | |
| | most inks, but special | to pagewidth print | High speed is | |
| | inks can be engineered | heads | difficult to achieve | |
| | for a 100:1 viscosity | | Requires | |
| | reduction. | | oscillating ink | |
| | | | pressure | |
| | | | A high | |
| | | | temperature | |
| | | | difference (typically | |
| | | | 80 degrees) is | |
| | | | required | |
| Acoustic | An acoustic wave is | Can operate | Complex drive | 1993 Hadimioglu |
| | generated and | without a nozzle | circuitry | et al, EUP 550,192 |
| | focussed upon the | plate | Complex | 1993 Elrod et al, |
| | drop ejection region. | | fabrication | EUP 572,220 |
| | | | Low efficiency | |
| | | | Poor control of | |
| | | | drop position | |
| | | | Poor control of | |
| | | | drop volume | |
| Thermo- | An actuator which | Low power | Efficient aqueous | IJ03, IJ09, IJ17, IJ18 |
| elastic bend | relies upon differential | consumption | operation requires a | IJ19, IJ20, IJ21, IJ22 |
| actuator | thermal expansion | Many ink types | thermal insulator on | IJ23, IJ24, IJ27, IJ28 |
| | upon Joule heating is | can be used | the hot side | IJ29, IJ30, IJ31, IJ32 |
| | used. | Simple planar | Corrosion | IJ33, IJ34, IJ35, IJ36 |
| | | fabrication | prevention can be | IJ37, IJ38 ,IJ39, IJ40 |
| | | Small chip area | difficult | IJ41 |
| | | required for each | Pigmented inks | |
| | | actuator | may be infeasible, | |
| | | Fast operation | as pigment particles | |
| | | High efficiency | may jam the bend | |
| | | CMOS | actuator | |
| | | compatible voltages | | |
| | | and currents | | |
| | | Standard MEMS | | |
| | | processes can be | | |
| | | used | | |
| | | Easy extension | | |
| | | from single nozzles | | |
| | | to pagewidth print | | |
| | | heads | | |
| High CTE | A material with a very | High force can | Requires special | IJ09, IJ17, IJ18, IJ20 |
| thermo- | high coefficient of | be generated | material (e.g. PTFE) | IJ21, IJ22, IJ23, IJ24 |
| elastic | thermal expansion | Three methods of | Requires a PTFE | IJ27, IJ28, IJ29, IJ30 |
| actuator | (CTE) such as | PTFE deposition are | deposition process, | IJ31, IJ42, IJ43, IJ44 |
| | polytetrafluoroethylene | under development: | which is not yet | |
| | (PTFE) is used. As | chemical vapor | standard in ULSI | |
| | high CTE materials | deposition (CVD), | fabs | |
| | are usually non- | spin coating, and | PTFE deposition | |
| | conductive, a heater | evaporation | cannot be followed | |
| | fabricated from a | PTFE is a candidate | with high | |
| | conductive material is | for low dielectric | temperature (above | |
| | incorporated. A 50 μm | constant insulation | 350° C.) processing | |
| | long PTFE bend | in ULSI | Pigmented inks | |
| | actuator with | Very low power | may be infeasible, | |
| | polysilicon heater and | consumption | as pigment particles | |
| | 15 mW power input | Many ink types | may jam the bend | |
| | can provide 180 | can be used | actuator | |
| | μN force | Simple planar | | |
| | and 10 μm | fabrication | | |
| | deflection. Actuator | Small chip area | | |
| | motions include: | required for each | | |
| | Bend | actuator | | |
| | Push | Fast operation | | |
| | Buckle | High efficiency | | |
| | Rotate | CMOS | | |
| | | compatible voltages | | |
| | | and currents | | |
| | | Easy extension | | |
| | | from single nozzles | | |
| | | to pagewidth print | | |
| | | heads | | |
| Conductive | A polymer with a high | High force can | Requires special | IJ24 |
| polymer | coefficient of thermal | be generated | materials | |
| thermo- | expansion (such as | Very low power | development (High | |
| elastic | PTFE) is doped with | consumption | CTE conductive | |
| actuator | conducting substances | Many ink types | polymer) | |
| | to increase its | can be used | Requires a PTFE | |
| | conductivity to about 3 | Simple planar | deposition process, | |
| | orders of magnitude | fabrication | which is not yet | |
| | below that of copper. | Small chip area | standard in ULSI | |
| | The conducting | required for each | fabs | |
| | polymer expands | actuator | PTFE deposition | |
| | when resistively | Fast operation | cannot be followed | |
| | heated. | High efficiency | with high | |
| | Examples of | CMOS | temperature (above | |
| | conducting dopants | compatible voltages | 350° C.) processing | |
| | include: | and currents | Evaporation and | |
| | Carbon nanotubes | Easy extension | CVD deposition | |
| | Metal fibers | from single nozzles | techniques cannot | |
| | Conductive polymers | to pagewidth print | be used | |
| | such as doped | heads | Pigmented inks | |
| | polythiophene | | may be infeasible, | |
| | Carbon granules | | as pigment particles | |
| | | | may jam the bend | |
| | | | actuator | |
| Shape | A shape memory alloy | High force is | Fatigue limits | IJ26 |
| memory | such as TiNi (also | available (stresses | maximum number | |
| alloy | known as Nitinol - | of hundreds of MPa) | of cycles | |
| | Nickel Titanium alloy | Large strain is | Low strain (1%) | |
| | developed at the Naval | available (more than | is required to extend | |
| | Ordnance Laboratory) | 3%) | fatigue resistance | |
| | is thermally switched | High corrosion | Cycle rate | |
| | between its weak | resistance | limited by heat | |
| | martensitic state and | Simple | removal | |
| | its high stiffness | construction | Requires unusual | |
| | austenic state. The | Easy extension | materials (TiNi) | |
| | shape of the actuator | from single nozzles | The latent heat of | |
| | in its martensitic state | to pagewidth print | transformation must | |
| | is deformed relative to | heads | be provided | |
| | the austenic shape. | Low voltage | High current | |
| | The shape change | operation | operation | |
| | causes ejection of a | | Requires pre- | |
| | drop. | | stressing to distort | |
| | | | the martensitic state | |
| Linear | Linear magnetic | Linear Magnetic | Requires unusual | IJ12 |
| Magnetic | actuators include the | actuators can be | semiconductor | |
| Actuator | Linear Induction | constructed with | materials such as | |
| | Actuator (LIA), Linear | high thrust, long | soft magnetic alloys | |
| | Permanent Magnet | travel, and high | (e.g. CoNiFe) | |
| | Synchronous Actuator | efficiency using | Some varieties | |
| | (LPMSA), Linear | planar | also require | |
| | Reluctance | semiconductor | permanent magnetic | |
| | Synchronous Actuator | fabrication | materials such as | |
| | (LRSA), Linear | techniques | Neodymium iron | |
| | Switched Reluctance | Long actuator | boron (NdFeB) | |
| | Actuator (LSRA), and | travel is available | Requires | |
| | the Linear Stepper | Medium force is | complex multi- | |
| | Actuator (LSA). | available | phase drive circuitry | |
| | | Low voltage | High current | |
| | | operation | operation | |

BASIC OPERATION MODE

| | Description | Advantages | Disadvantages | Examples |
|---|---|---|---|---|
| Actuator | This is the simplest | Simple operation | Drop repetition | Thermal ink jet |
| directly | mode of operation: the | No external | rate is usually | Piezoelectric inkjet |
| pushes ink | actuator directly | fields required | limited to around 10 | IJ01, IJ02, IJ03, IJ04 |
| | supplies sufficient | Satellite drops | KHz. However, this | IJ05, IJ06, IJ07, IJ09 |
| | kinetic energy to expel | can be avoided if | is not fundamental | IJ11, IJ12, IJ14, IJ16 |
| | the drop. The drop | drop velocity is less | to the method, but is | IJ20, IJ22, IJ23, IJ24 |
| | must have a sufficient | than 4 m/s | related to the refill | IJ25, IJ26, IJ27, IJ28 |
| | velocity to overcome | Can be efficient, | method normally | IJ29, IJ30, IJ31, IJ32 |
| | the surface tension. | depending upon the | used | IJ33, IJ34, IJ35, IJ36 |
| | | actuator used | All of the drop | IJ37, IJ38, IJ39, IJ40 |
| | | | kinetic energy must | IJ41, IJ42, IJ43, IJ44 |
| | | | be provided by the | |
| | | | actuator | |
| | | | Satellite drops | |
| | | | usually form if drop | |
| | | | velocity is greater | |
| | | | than 4.5 m/s | |
| Proximity | The drops to be | Very simple print | Requires close | Silverbrook, EP |
| | printed are selected by | head fabrication can | proximity between | 0771 658 A2 and |
| | some manner (e.g. | be used | the print head and | related patent |
| | thermally induced | The drop | the print media or | applications |
| | surface tension | selection means | transfer roller | |
| | reduction of | does not need to | May require two | |
| | pressurized ink). | provide the energy | print heads printing | |
| | Selected drops are | required to separate | alternate rows of the | |
| | separated from the ink | the drop from the | image | |
| | in the nozzle by | nozzle | Monolithic color | |
| | contact with the print | | print heads are | |
| | medium or a transfer | | difficult | |
| | roller. | | | |
| Electro- | The drops to be | Very simple print | Requires very | Silverbrook, EP |
| static pull | printed are selected by | head fabrication can | high electrostatic | 0771 658 A2 and |
| on ink | some manner (e.g. | be used | field | related patent |
| | thermally induced | The drop | Electrostatic field | applications |
| | surface tension | selection means | for small nozzle | Tone-Jet |
| | reduction of | does not need to | sizes is above air | |
| | pressurized ink). | provide the energy | breakdown | |
| | Selected drops are | required to separate | Electrostatic field | |
| | separated from the ink | the drop from the | may attract dust | |
| | in the nozzle by a | nozzle | | |
| | strong electric field. | | | |
| Magnetic | The drops to be | Very simple print | Requires | Silverbrook, EP |
| pull on ink | printed are selected by | head fabrication can | magnetic ink | 0771 658 A2 and |
| | some manner (e.g. | be used | Ink colors other | related patent |
| | thermally induced | The drop | than black are | applications |
| | surface tension | selection means | difficult | |
| | reduction of | does not need to | Requires very | |
| | pressurized ink). | provide the energy | high magnetic fields | |
| | Selected drops are | required to separate | | |
| | separated from the ink | the drop from the | | |
| | in the nozzle by a | nozzle | | |
| | strong magnetic field | | | |
| | acting on the magnetic | | | |
| | ink. | | | |
| Shutter | The actuator moves a | High speed (>50 | Moving parts are | IJ13, IJ17, IJ21 |
| | shutter to block ink | KHz) operation can | required | |
| | flow to the nozzle. The | be achieved due to | Requires ink | |
| | ink pressure is pulsed | reduced refill time | pressure modulator | |
| | at a multiple of the | Drop timing can | Friction and wear | |
| | drop ejection | be very accurate | must be considered | |
| | frequency. | The actuator | Stiction is | |
| | | energy can be very | possible | |
| | | low | | |
| Shuttered | The actuator moves a | Actuators with | Moving parts are | IJ08, IJ15, IJ18, IJ19 |
| grill | shutter to block ink | small travel can be | required | |
| | flow through a grill to | used | Requires ink | |
| | the nozzle. The shutter | Actuators with | pressure modulator | |
| | movement need only | small force can be | Friction and wear | |
| | be equal to the width | used | must be considered | |
| | of the grill holes. | High speed (>50 | Stiction is | |
| | | KHz) operation can | possible | |
| | | be achieved | | |
| Pulsed | A pulsed magnetic | Extremely low | Requires an | IJ10 |
| magnetic | field attracts an ‘ink | energy operation is | external pulsed | |
| pull on ink | pusher’ at the drop | possible | magnetic field | |
| pusher | ejection frequency. An | No heat | Requires special | |
| | actuator controls a | dissipation | materials for both | |
| | catch, which prevents | problems | the actuator and the | |
| | the ink pusher from | | ink pusher | |
| | moving when a drop is | | Complex | |
| | not to be ejected. | | construction | |

AUXILIARY MECHANISM (APPLIED TO ALL NOZZLES)

| | Description | Advantages | Disadvantages | Examples |
|---|---|---|---|---|
| None | The actuator directly | Simplicity of | Drop ejection | Most inkjets, |
| | fires the ink drop, and | construction | energy must be | including |
| | there is no external | Simplicity of | supplied by | piezoelectric and |
| | field or other | operation | individual nozzle | thermal bubble. |
| | mechanism required. | Small physical | actuator | IJ01, IJ02, IJ03, IJ04, |
| | | size | | IJ05, IJ07, IJ09, IJ11 |
| | | | | IJ12, IJ14, IJ20, IJ22 |
| | | | | IJ23, IJ24, IJ25, IJ26, |
| | | | | IJ27, IJ28, IJ29, IJ30, |
| | | | | IJ31, IJ32, IJ033, IJ34, |
| | | | | IJ35, IJ36, IJ37, IJ38, |
| | | | | IJ39, IJ40, IJ41, IJ42, |
| | | | | IJ43, IJ44 |
| Oscillating | The ink pressure | Oscillating ink | Requires external | Silverbrook, EP |
| ink pressure | oscillates, providing | pressure can provide | ink pressure | 0771 658 A2 and |
| (including | much of the drop | a refill pulse, | oscillator | related patent |
| acoustic | ejection energy. The | allowing higher | Ink pressure | applications |
| stimulation) | actuator selects which | operating speed | phase and amplitude | IJ08, IJ13, IJ15, IJ17 |
| | drops are to be fired | The actuators | must be carefully | IJ18, IJ19, IJ21 |
| | by selectively | may operate with | controlled | |
| | blocking or enabling | much lower energy | Acoustic | |
| | nozzles. The ink | Acoustic lenses | reflections in the ink | |
| | pressure oscillation | can be used to focus | chamber must be | |
| | may be achieved by | the sound on the | designed for | |
| | vibrating the print | nozzles | | |
| | head, or preferably by | | | |
| | an actuator in the ink | | | |
| | supply. | | | |
| Media | The print head is | Low power | Precision | Silverbrook, EP |
| proximity | placed in close | High accuracy | assembly required | 0771 658 A2 and |
| | proximity to the print | Simple print head | Paper fibers may | related patent |
| | medium. Selected | construction | cause problems | applications |
| | drops protrude from | | Cannot print on | |
| | the print head further | | rough substrates | |
| | than unselected drops, | | | |
| | and contact the print | | | |
| | medium. The drop | | | |
| | soaks into the medium | | | |
| | fast enough to cause | | | |
| | drop separation. | | | |
| Transfer | Drops are printed to a | High accuracy | Bulky | Silverbrook, EP |
| roller | transfer roller instead | Wide range of | Expensive | 0771 658 A2 and |
| | of straight to the print | print substrates can | Complex | related patent |
| | medium. A transfer | be used | construction | applications |
| | roller can also be used | Ink can be dried | | Tektronix hot |
| | for proximity drop | on the transfer roller | | melt piezoelectric |
| | separation. | | | inkjet |
| | | | | Any of the IJ |
| | | | | series |
| Electro- | An electric field is | Low power | Field strength | Silverbrook, EP |
| static | used to accelerate | Simple print head | required for | 0771 658 A2 and |
| | selected drops towards | construction | separation of small | related patent |
| | the print medium. | | drops is near or | applications |
| | | | above air breakdown | Tone-Jet |
| Direct | A magnetic field is | Low power | Requires | Silverbrook, EP |
| magnetic | used to accelerate | Simple print head | magnetic ink | 0771 658 A2 and |
| field | selected drops of | construction | Requires strong | related patent |
| | magnetic ink towards | | magnetic field | applications |
| | the print medium. | | | |
| Cross | The print head is | Does not require | Requires external | IJ06, IJ16 |
| magnetic | placed in a constant | magnetic materials | magnet | |
| field | magnetic field. The | to be integrated in | Current densities | |
| | Lorenz force in a | the print head | may be high, | |
| | current carrying wire | manufacturing | resulting in | |
| | is used to move the | process | electromigration | |
| | actuator. | | problems | |
| Pulsed | A pulsed magnetic | Very low power | Complex print | IJ10 |
| magnetic | field is used to | operation is possible | head construction | |
| field | cyclically attract a | Small print head | Magnetic | |
| | paddle, which pushes | size | materials required in | |
| | on the ink. A small | | print head | |
| | actuator moves a | | | |
| | catch, which | | | |
| | selectively prevents | | | |
| | the paddle from | | | |
| | moving. | | | |

ACTUATOR AMPLIFICATION OR MODIFICATION METHOD

| | Description | Advantages | Disadvantages | Examples |
|---|---|---|---|---|
| None | No actuator | Operational | Many actuator | Thermal |
| | mechanical | simplicity | mechanisms | Bubble Ink jet |
| | amplification is | | have insufficient | IJ01, IJ02, |
| | used. The actuator | | travel, or | IJ06, IJ07, IJ16, |
| | directly drives the | | insufficient | IJ25, IJ26 |
| | drop ejection | | force, to | |
| | process. | | efficiently drive | |
| | | | the drop ejection | |
| | | | process | |
| Differential | An actuator | Provides | High stresses | Piezoelectric |
| expansion | material expands | greater travel in | are involved | IJ03, IJ09, |
| bend | more on one side | a reduced print | Care must be | IJ17, IJ18, IJ19, |
| actuator | than on the other. | head area | taken that the | IJ20, IJ21, IJ22, |
| | The expansion | | materials do not | IJ23, IJ24, IJ27, |
| | may be thermal, | | delaminate | IJ29, IJ30, IJ31, |
| | piezoelectric, | | Residual bend | IJ32, IJ33, IJ34, |
| | magnetostrictive, | | resulting from | IJ35, IJ36, IJ37, |
| | or other | | high temperature | IJ38, IJ39, IJ42, |
| | mechanism. The | | or high stress | IJ43, IJ44 |
| | bend actuator | | during formation | |
| | converts a high | | | |
| | force low travel | | | |
| | actuator | | | |
| | mechanism to high | | | |
| | travel, lower force | | | |
| | mechanism. | | | |
| Transient | A trilayer bend | Very good | High stresses | IJ40, IJ41 |
| bend | actuator where the | temperature | are involved | |
| actuator | two outside layers | stability | Care must be | |
| | are identical. This | High speed, as | taken that the | |
| | cancels bend due | a new drop can | materials do not | |
| | to ambient | be fired before | delaminate | |
| | temperature and | heat dissipates | | |
| | residual stress. The | Cancels | | |
| | actuator only | residual stress of | | |
| | responds to | formation | | |
| | transient heating of | | | |
| | one side or the | | | |
| | other. | | | |
| Reverse | The actuator loads | Better | Fabrication | IJ05, IJ11 |
| spring | a spring. When the | coupling to the | complexity | |
| | actuator is turned | ink | High stress in | |
| | off, the spring | | the spring | |
| | releases. This can | | | |
| | reverse the | | | |
| | force/distance | | | |
| | curve of the | | | |
| | actuator to make it | | | |
| | compatible with | | | |
| | the force/time | | | |
| | requirements of | | | |
| | the drop ejection. | | | |
| Actuator | A series of thin | Increased | Increased | Some |
| stack | actuators are | travel | fabrication | piezoelectric ink |
| | stacked. This can | Reduced drive | complexity | jets |
| | be appropriate | voltage | Increased | IJ04 |
| | where actuators | | possibility of | |
| | require high | | short circuits due | |
| | electric field | | to pinholes | |
| | strength, such as | | | |
| | electrostatic and | | | |
| | piezoelectric | | | |
| | actuators. | | | |
| Multiple | Multiple smaller | Increases the | Actuator | IJ12, IJ13, |
| actuators | actuators are used | force available | forces may not | IJ18, IJ20, IJ22, |
| | simultaneously to | from an actuator | add linearly, | IJ28, IJ42, IJ43 |
| | move the ink. Each | Multiple | reducing | |
| | actuator need | actuators can be | efficiency | |
| | provide only a | positioned to | | |
| | portion of the | control ink flow | | |
| | force required. | accurately | | |
| Linear | A linear spring is | Matches low | Requires print | IJ15 |
| Spring | used to transform a | travel actuator | head area for the | |
| | motion with small | with higher | spring | |
| | travel and high | travel | | |
| | force into a longer | requirements | | |
| | travel, lower force | Non-contact | | |
| | motion. | method of | | |
| | | motion | | |
| | | transformation | | |
| Coiled | A bend actuator is | Increases | Generally | IJ17, IJ21, |
| actuator | coiled to provide | travel | restricted to | IJ34, IJ35 |
| | greater travel in a | Reduces chip | planar | |
| | reduced chip area. | area | implementations | |
| | | Planar | due to extreme | |
| | | implementations | fabrication | |
| | | are relatively | difficulty in | |
| | | easy to fabricate. | other | |
| | | | orientations. | |
| Flexure | A bend actuator | Simple means | Care must be | IJ10, IJ19, |
| bend | has a small region | of increasing | taken not to | IJ33 |
| actuator | near the fixture | travel of a bend | exceed the | |
| | point, which flexes | actuator | elastic limit in | |
| | much more readily | | the flexure area | |
| | than the remainder | | Stress | |
| | of the actuator. | | distribution is | |
| | The actuator | | very uneven | |
| | flexing is | | Difficult to | |
| | effectively | | accurately model | |
| | converted from an | | with finite | |
| | even coiling to an | | element analysis | |
| | angular bend, | | | |
| | resulting in greater | | | |
| | travel of the | | | |
| | actuator tip. | | | |
| Catch | The actuator | Very low | Complex | IJ10 |
| | controls a small | actuator energy | construction | |
| | catch. The catch | Very small | Requires | |
| | either enables or | actuator size | external force | |
| | disables movement | | Unsuitable for | |
| | of an ink pusher | | pigmented inks | |
| | that is controlled | | | |
| | in a bulk manner. | | | |
| Gears | Gears can be used | Low force, | Moving parts | IJ13 |
| | to increase travel | low travel | are required | |
| | at the expense of | actuators can be | Several | |
| | duration. Circular | used | actuator cycles | |
| | gears, rack and | Can be | are required | |
| | pinion, ratchets, | fabricated using | More complex | |
| | and other gearing | standard surface | drive electronics | |
| | methods can be | MEMS | Complex | |
| | used. | processes | construction | |
| | | | Friction, | |
| | | | friction, and | |
| | | | wear are | |
| | | | possible | |
| Buckle | A buckle plate can | Very fast | Must stay | S. Hirata et al, |
| plate | be used to change | movement | within elastic | “An Ink-jet |
| | a slow actuator | achievable | limits of the | Head Using |
| | into a fast motion. | | materials for | Diaphragm |
| | It can also convert | | long device life | Microactuator”, |
| | a high force, low | | High stresses | Proc. IEEE |
| | travel actuator into | | involved | MEMS, February |
| | a high travel, | | Generally | 1996, pp 418-423. |
| | medium force | | high power | IJ18, IJ27 |
| | motion. | | requirement | |
| Tapered | A tapered | Linearizes the | Complex | IJ14 |
| magnetic | magnetic pole can | magnetic | construction | |
| pole | increase travel at | force/distance | | |
| | the expense of | curve | | |
| | force. | | | |
| Lever | A lever and | Matches low | High stress | IJ32, IJ36, |
| | fulcrum is used to | travel actuator | around the | IJ37 |
| | transform a motion | with higher | fulcrum | |
| | with small travel | travel | | |
| | and high force into | requirements | | |
| | a motion with | Fulcrum area | | |
| | longer travel and | has no linear | | |
| | lower force. The | movement, and | | |
| | lever can also | can be used for a | | |
| | reverse the | fluid seal | | |
| | direction of travel. | | | |
| Rotary | The actuator is | High | Complex | IJ28 |
| impeller | connected to a | mechanical | construction | |
| | rotary impeller. A | advantage | Unsuitable for | |
| | small angular | The ratio of | pigmented inks | |
| | deflection of the | force to travel of | | |
| | actuator results in | the actuator can | | |
| | a rotation of the | be matched to | | |
| | impeller vanes, | the nozzle | | |
| | which push the ink | requirements by | | |
| | against stationary | varying the | | |
| | vanes and out of | number of | | |
| | the nozzle. | impeller vanes | | |
| Acoustic | A refractive or | No moving | Large area | 1993 |
| lens | diffractive (e.g. | parts | required | Hadimioglu et |
| | zone plate) | | Only relevant | al, EUP 550,192 |
| | acoustic lens is | | for acoustic ink | 1993 Elrod et |
| | used to concentrate | | jets | al, EUP 572,220 |
| | sound waves. | | | |
| Sharp | A sharp point is | Simple | Difficult to | Tone-jet |
| conductive | used to concentrate | construction | fabricate using | |
| point | an electrostatic | | standard VLSI | |
| | field. | | processes for a | |
| | | | surface ejecting | |
| | | | ink-jet | |
| | | | Only relevant | |
| | | | for electrostatic | |
| | | | ink jets | |

ACTUATOR MOTION

| | Description | Advantages | Disadvantages | Examples |
|---|---|---|---|---|
| Volume | The volume of the | Simple | High energy is | Hewlett- |
| expansion | actuator changes, | construction in | typically | Packard Thermal |
| | pushing the ink in | the case of | required to | Ink jet |
| | all directions. | thermal ink jet | achieve volume | Canon |
| | | | expansion. This | Bubblejet |
| | | | leads to thermal | |
| | | | stress, cavitation, | |
| | | | and kogation in | |
| | | | thermal ink jet | |
| | | | implementations | |
| Linear, | The actuator | Efficient | High | IJ01, IJ02, |
| normal to | moves in a | coupling to ink | fabrication | IJ04, IJ07, IJ11, |
| chip | direction normal to | drops ejected | complexity may | IJ14 |
| surface | the print head | normal to the | be required to | |
| | surface. The | surface | achieve | |
| | nozzle is typically | | perpendicular | |
| | in the line of | | motion | |
| | movement. | | | |
| Parallel to | The actuator | Suitable for | Fabrication | IJ12, IJ13, |
| chip | moves parallel to | planar | complexity | IJ15, IJ33,, IJ34, |
| surface | the print head | fabrication | Friction | IJ35, IJ36 |
| | surface. Drop | | Stiction | |
| | ejection may still | | | |
| | be normal to the | | | |
| | surface. | | | |
| Membrane | An actuator with a | The effective | Fabrication | 1982 Howkins |
| push | high force but | area of the | complexity | U.S. Pat. No. 4,459,601 |
| | small area is used | actuator | Actuator size | |
| | to push a stiff | becomes the | Difficulty of | |
| | membrane that is | membrane area | integration in a | |
| | in contact with the | | VLSI process | |
| | ink. | | | |
| Rotary | The actuator | Rotary levers | Device | IJ05, IJ08, |
| | causes the rotation | may be used to | complexity | IJ13, IJ28 |
| | of some element, | increase travel | May have | |
| | such a grill or | Small chip | friction at a pivot | |
| | impeller | area | point | |
| | | requirements | | |
| Bend | The actuator bends | A very small | Requires the | 1970 Kyser et |
| | when energized. | change in | actuator to be | al U.S. Pat. No. |
| | This may be due to | dimensions can | made from at | 3,946,398 |
| | differential | be converted to a | least two distinct | 1973 Stemme |
| | thermal expansion, | large motion. | layers, or to have | U.S. Pat. No. 3,747,120 |
| | piezoelectric | | a thermal | IJ03, IJ09, |
| | expansion, | | difference across | IJ10, IJ19, IJ23, |
| | magnetostriction, | | the actuator | IJ24, IJ25, IJ29, |
| | or other form of | | | IJ30, IJ31, IJ33, |
| | relative | | | IJ34, IJ35 |
| | dimensional | | | |
| | change. | | | |
| Swivel | The actuator | Allows | Inefficient | IJ06 |
| | swivels around a | operation where | coupling to the | |
| | central pivot. This | the net linear | ink motion | |
| | motion is suitable | force on the | | |
| | where there are | paddle is zero | | |
| | opposite forces | Small chip | | |
| | applied to opposite | area | | |
| | sides of the paddle, | requirements | | |
| | e.g. Lorenz force. | | | |
| Straighten | The actuator is | Can be used | Requires | IJ26, IJ32 |
| | normally bent, and | with shape | careful balance | |
| | straightens when | memory alloys | of stresses to | |
| | energized. | where the | ensure that the | |
| | | austenic phase is | quiescent bend is | |
| | | planar | accurate | |
| Double | The actuator bends | One actuator | Difficult to | IJ36, IJ37, |
| bend | in one direction | can be used to | make the drops | IJ38 |
| | when one element | power two | ejected by both | |
| | is energized, and | nozzles. | bend directions | |
| | bends the other | Reduced chip | identical. | |
| | way when another | size. | A small | |
| | element is | Not sensitive | efficiency loss | |
| | energized. | to ambient | compared to | |
| | | temperature | equivalent single | |
| | | | bend actuators. | |
| Shear | Energizing the | Can increase | Not readily | 1985 Fishbeck |
| | actuator causes a | the effective | applicable to | U.S. Pat. No. 4,584,590 |
| | shear motion in the | travel of | other actuator | |
| | actuator material. | piezoelectric | mechanisms | |
| | | actuators | | |
| Radial | The actuator | Relatively | High force | 1970 Zoltan |
| constriction | squeezes an ink | easy to fabricate | required | U.S. Pat. No. 3,683,212 |
| | reservoir, forcing | single nozzles | Inefficient | |
| | ink from a | from glass | Difficult to | |
| | constricted nozzle. | tubing as | integrate with | |
| | | macroscopic | VLSI processes | |
| | | structures | | |
| Coil/ | A coiled actuator | Easy to | Difficult to | IJ17, IJ21, |
| uncoil | uncoils or coils | fabricate as a | fabricate for | IJ34, IJ35 |
| | more tightly. The | planar VLSI | non-planar | |
| | motion of the free | process | devices | |
| | end of the actuator | Small area | Poor out-of- | |
| | ejects the ink. | required, | plane stiffness | |
| | | therefore low | | |
| | | cost | | |
| Bow | The actuator bows | Can increase | Maximum | IJ16, IJ18, |
| | (or buckles) in the | the speed of | travel is | IJ27 |
| | middle when | travel | constrained | |
| | energized. | Mechanically | High force | |
| | | rigid | required | |
| Push-Pull | Two actuators | The structure | Not readily | IJ18 |
| | control a shutter. | is pinned at both | suitable for ink | |
| | One actuator pulls | ends, so has a | jets which | |
| | the shutter, and the | high out-of- | directly push the | |
| | other pushes it. | plane rigidity | ink | |
| Curl | A set of actuators | Good fluid | Design | IJ20, IJ42 |
| inwards | curl inwards to | flow to the | complexity | |
| | reduce the volume | region behind | | |
| | of ink that they | the actuator | | |
| | enclose. | increases | | |
| | | efficiency | | |
| Curl | A set of actuators | Relatively | Relatively | IJ43 |
| outwards | curl outwards, | simple | large chip area | |
| | pressurizing ink in | construction | | |
| | a chamber | | | |
| | surrounding the | | | |
| | actuators, and | | | |
| | expelling ink from | | | |
| | a nozzle in the | | | |
| | chamber. | | | |
| Iris | Multiple vanes | High | High | IJ22 |
| | enclose a volume | efficiency | fabrication | |
| | of ink. These | Small chip | complexity | |
| | simultaneously | area | Not suitable | |
| | rotate, reducing | | for pigmented | |
| | the volume | | inks | |
| | between the vanes. | | | |
| Acoustic | The actuator | The actuator | Large area | 1993 |
| vibration | vibrates at a high | can be | required for | Hadimioglu et |
| | frequency. | physically | efficient | al, EUP 550,192 |
| | | distant from the | operation at | 1993 Elrod et |
| | | ink | useful | al, EUP 572,220 |
| | | | frequencies | |
| | | | Acoustic | |
| | | | coupling and | |
| | | | crosstalk | |
| | | | Complex | |
| | | | drive circuitry | |
| | | | Poor control | |
| | | | of drop volume | |
| | | | and position | |
| None | In various ink jet | No moving | Various other | Silverbrook, |
| | designs the | parts | tradeoffs are | EP 0771 658 A2 |
| | actuator does not | | required to | and related |
| | move. | | eliminate | patent |
| | | | moving parts | applications |
| | | | | Tone-jet |

NOZZLE REFILL METHOD

| | Description | Advantages | Disadvantages | Examples |
|---|---|---|---|---|
| Surface | This is the normal | Fabrication | Low speed | Thermal ink |
| tension | way that ink jets | simplicity | Surface | jet |
| | are refilled. After | Operational | tension force | Piezoelectric |
| | the actuator is | simplicity | relatively small | ink jet |
| | energized, it | | compared to | IJ01-IJ07, |
| | typically returns | | actuator force | IJ10-IJ14, IJ16, |
| | rapidly to its | | Long refill | IJ20, IJ22-IJ45 |
| | normal position. | | time usually | |
| | This rapid return | | dominates the | |
| | sucks in air | | total repetition | |
| | through the nozzle | | rate | |
| | opening. The ink | | | |
| | surface tension at | | | |
| | the nozzle then | | | |
| | exerts a small | | | |
| | force restoring the | | | |
| | meniscus to a | | | |
| | minimum area. | | | |
| | This force refills | | | |
| | the nozzle. | | | |
| Shuttered | Ink to the nozzle | High speed | Requires | IJ08, IJ13, |
| oscillating | chamber is | Low actuator | common ink | IJ15, IJ17, IJ18, |
| ink | provided at a | energy, as the | pressure | IJ19, IJ21 |
| pressure | pressure that | actuator need | oscillator | |
| | oscillates at twice | only open or | May not be | |
| | the drop ejection | close the shutter, | suitable for | |
| | frequency. When a | instead of | pigmented inks | |
| | drop is to be | ejecting the ink | | |
| | ejected, the shutter | drop | | |
| | is opened for 3 | | | |
| | half cycles: drop | | | |
| | ejection, actuator | | | |
| | return, and refill. | | | |
| | The shutter is then | | | |
| | closed to prevent | | | |
| | the nozzle | | | |
| | chamber emptying | | | |
| | during the next | | | |
| | negative pressure | | | |
| | cycle. | | | |
| Refill | After the main | High speed, as | Requires two | IJ09 |
| actuator | actuator has | the nozzle is | independent | |
| | ejected a drop a | actively refilled | actuators per | |
| | second (refill) | | nozzle | |
| | actuator is | | | |
| | energized. The | | | |
| | refill actuator | | | |
| | pushes ink into the | | | |
| | nozzle chamber. | | | |
| | The refill actuator | | | |
| | returns slowly, to | | | |
| | prevent its return | | | |
| | from emptying the | | | |
| | chamber again. | | | |
| Positive | The ink is held a | High refill | Surface spill | Silverbrook, |
| ink | slight positive | rate, therefore a | must be | EP 0771 658 A2 |
| pressure | pressure. After the | high drop | prevented | and related |
| | ink drop is ejected, | repetition rate is | Highly | patent |
| | the nozzle | possible | hydrophobic | applications |
| | chamber fills | | print head | Alternative |
| | quickly as surface | | surfaces are | for:, IJ01-IJ07, |
| | tension and ink | | required | IJ10-IJ14, IJ16, |
| | pressure both | | | IJ20, IJ22-IJ45 |
| | operate to refill the | | | |
| | nozzle. | | | |

METHOD OF RESTRICTING BACK-FLOW THROUGH INLET

| | Description | Advantages | Disadvantages | Examples |
|---|---|---|---|---|
| Long inlet | The ink inlet | Design | Restricts refill | Thermal ink |
| channel | channel to the | simplicity | rate | jet |
| | nozzle chamber is | Operational | May result in | Piezoelectric |
| | made long and | simplicity | a relatively large | ink jet |
| | relatively narrow, | Reduces | chip area | IJ42, IJ43 |
| | relying on viscous | crosstalk | Only partially | |
| | drag to reduce | | effective | |
| | inlet back-flow. | | | |
| Positive | The ink is under a | Drop selection | Requires a | Silverbrook, |
| ink | positive pressure, | and separation | method (such as | EP 0771 658 A2 |
| pressure | so that in the | forces can be | a nozzle rim or | and related |
| | quiescent state | reduced | effective | patent |
| | some of the ink | Fast refill time | hydrophobizing, | applications |
| | drop already | | or both) to | Possible |
| | protrudes from the | | prevent flooding | operation of the |
| | nozzle. | | of the ejection | following: IJ01-IJ07, |
| | This reduces the | | surface of the | IJ09-IJ12, |
| | pressure in the | | print head. | IJ14, IJ16, IJ20, |
| | nozzle chamber | | | IJ22,, IJ23-IJ34, |
| | which is required | | | IJ36-IJ41, IJ44 |
| | to eject a certain | | | |
| | volume of ink. The | | | |
| | reduction in | | | |
| | chamber pressure | | | |
| | results in a | | | |
| | reduction in ink | | | |
| | pushed out through | | | |
| | the inlet. | | | |
| Baffle | One or more | The refill rate | Design | HP Thermal |
| | baffles are placed | is not as | complexity | Ink Jet |
| | in the inlet ink | restricted as the | May increase | Tektronix |
| | flow. When the | long inlet | fabrication | piezoelectric ink |
| | actuator is | method. | complexity (e.g. | jet |
| | energized, the | Reduces | Tektronix hot | |
| | rapid ink | crosstalk | melt | |
| | movement creates | | Piezoelectric | |
| | eddies which | | print heads). | |
| | restrict the flow | | | |
| | through the inlet. | | | |
| | The slower refill | | | |
| | process is | | | |
| | unrestricted, and | | | |
| | does not result in | | | |
| | eddies. | | | |
| Flexible | In this method | Significantly | Not applicable | Canon |
| flap | recently disclosed | reduces back- | to most ink jet | |
| restricts | by Canon, the | flow for edge- | configurations | |
| inlet | expanding actuator | shooter thermal | Increased | |
| | (bubble) pushes on | ink jet devices | fabrication | |
| | a flexible flap that | | complexity | |
| | restricts the inlet. | | Inelastic | |
| | | | deformation of | |
| | | | polymer flap | |
| | | | results in creep | |
| | | | over extended | |
| | | | use | |
| Inlet filter | A filter is located | Additional | Restricts refill | IJ04, IJ12, |
| | between the ink | advantage of ink | rate | IJ24, IJ27, IJ29, |
| | inlet and the | filtration | May result in | IJ30 |
| | nozzle chamber. | Ink filter may | complex | |
| | The filter has a | be fabricated | construction | |
| | multitude of small | with no | | |
| | holes or slots, | additional | | |
| | restricting ink | process steps | | |
| | flow. The filter | | | |
| | also removes | | | |
| | particles which | | | |
| | may block the | | | |
| | nozzle. | | | |
| Small | The ink inlet | Design | Restricts refill | IJ02, IJ37, |
| inlet | channel to the | simplicity | rate | IJ44 |
| compared | nozzle chamber | | May result in | |
| to nozzle | has a substantially | | a relatively large | |
| | smaller cross | | chip area | |
| | section than that of | | Only partially | |
| | the nozzle, | | effective | |
| | resulting in easier | | | |
| | ink egress out of | | | |
| | the nozzle than out | | | |
| | of the inlet. | | | |
| Inlet | A secondary | Increases | Requires | IJ09 |
| shutter | actuator controls | speed of the ink- | separate refill | |
| | the position of a | jet print head | actuator and | |
| | shutter, closing off | operation | drive circuit | |
| | the ink inlet when | | | |
| | the main actuator | | | |
| | is energized. | | | |
| The inlet | The method avoids | Back-flow | Requires | IJ01, IJ03, |
| is located | the problem of | problem is | careful design to | IJ05, IJ06, IJ07, |
| behind | inlet back-flow by | eliminated | minimize the | IJ10, IJ11, IJ14, |
| the ink- | arranging the ink- | | negative | IJ16, IJ22, IJ23, |
| pushing | pushing surface of | | pressure behind | IJ25, IJ28, IJ31, |
| surface | the actuator | | the paddle | IJ32, IJ33, IJ34, |
| | between the inlet | | | IJ35, IJ36, IJ39, |
| | and the nozzle. | | | IJ40, IJ41 |
| Part of | The actuator and a | Significant | Small increase | IJ07, IJ20, |
| the | wall of the ink | reductions in | in fabrication | IJ26, IJ38 |
| actuator | chamber are | back-flow can be | complexity | |
| moves to | arranged so that | achieved | | |
| shut off | the motion of the | Compact | | |
| the inlet | actuator closes off | designs possible | | |
| | the inlet. | | | |
| Nozzle | In some | Ink back-flow | None related | Silverbrook, |
| actuator | configurations of | problem is | to ink back-flow | EP 0771 658 A2 |
| does not | ink jet, there is no | eliminated | on actuation | and related |
| result in | expansion or | | | patent |
| ink back- | movement of an | | | applications |
| flow | actuator which | | | Valve-jet |
| | may cause ink | | | Tone-jet |
| | back-flow through | | | |
| | the inlet. | | | |

NOZZLE CLEARING METHOD

| | Description | Advantages | Disadvantages | Examples |
|---|---|---|---|---|
| Normal | All of the nozzles | No added | May not be | Most ink jet |
| nozzle | are fired | complexity on | sufficient to | systems |
| firing | periodically, | the print head | displace dried | IJ01, IJ02, |
| | before the ink has | | ink | IJ03, IJ04, IJ05, |
| | a chance to dry. | | | IJ06, IJ07, IJ09, |
| | When not in use | | | IJ10, IJ11, IJ12, |
| | the nozzles are | | | IJ14, IJ16, IJ20, |
| | sealed (capped) | | | IJ22, IJ23, IJ24, |
| | against air. | | | IJ25, IJ26, IJ27, |
| | The nozzle firing | | | IJ28, IJ29, IJ30, |
| | is usually | | | IJ31, IJ32, IJ33, |
| | performed during a | | | IJ34, IJ36, IJ37, |
| | special clearing | | | IJ38, IJ39, IJ40,, |
| | cycle, after first | | | IJ41, IJ42, IJ43, |
| | moving the print | | | IJ44,, IJ45 |
| | head to a cleaning | | | |
| | station. | | | |
| Extra | In systems which | Can be highly | Requires | Silverbrook, |
| power to | heat the ink, but do | effective if the | higher drive | EP 0771 658 A2 |
| ink heater | not boil it under | heater is | voltage for | and related |
| | normal situations, | adjacent to the | clearing | patent |
| | nozzle clearing can | nozzle | May require | applications |
| | be achieved by | | larger drive | |
| | over-powering the | | transistors | |
| | heater and boiling | | | |
| | ink at the nozzle. | | | |
| Rapid | The actuator is | Does not | Effectiveness | May be used |
| succession | fired in rapid | require extra | depends | with: IJ01, IJ02, |
| of | succession. In | drive circuits on | substantially | IJ03, IJ04, IJ05, |
| actuator | some | the print head | upon the | IJ06, IJ07, IJ09, |
| pulses | configurations, this | Can be readily | configuration of | IJ10, IJ11, IJ14, |
| | may cause heat | controlled and | the ink jet nozzle | IJ16, IJ20, IJ22, |
| | build-up at the | initiated by | | IJ23, IJ24, IJ25, |
| | nozzle which boils | digital logic | | IJ27, IJ28, IJ29, |
| | the ink, clearing | | | IJ30, IJ31, IJ32, |
| | the nozzle. In other | | | IJ33, IJ34, IJ36, |
| | situations, it may | | | IJ37, IJ38, IJ39, |
| | cause sufficient | | | IJ40, IJ41, IJ42, |
| | vibrations to | | | IJ43, IJ44, IJ45 |
| | dislodge clogged | | | |
| | nozzles. | | | |
| Extra | Where an actuator | A simple | Not suitable | May be used |
| power to | is not normally | solution where | where there is a | with: IJ03, IJ09, |
| ink | driven to the limit | applicable | hard limit to | IJ16, IJ20, IJ23, |
| pushing | of its motion, | | actuator | IJ24, IJ25, IJ27, |
| actuator | nozzle clearing | | movement | IJ29, IJ30, IJ31, |
| | may be assisted by | | | IJ32, IJ39, IJ40, |
| | providing an | | | IJ41, IJ42, IJ43, |
| | enhanced drive | | | IJ44, IJ45 |
| | signal to the | | | |
| | actuator. | | | |
| Acoustic | An ultrasonic | A high nozzle | High | IJ08, IJ13, |
| resonance | wave is applied to | clearing | implementation | IJ15, IJ17, IJ18, |
| | the ink chamber. | capability can be | cost if system | IJ19, IJ21 |
| | This wave is of an | achieved | does not already | |
| | appropriate | May be | include an | |
| | amplitude and | implemented at | acoustic actuator | |
| | frequency to cause | very low cost in | | |
| | sufficient force at | systems which | | |
| | the nozzle to clear | already include | | |
| | blockages. This is | acoustic | | |
| | easiest to achieve | actuators | | |
| | if the ultrasonic | | | |
| | wave is at a | | | |
| | resonant frequency | | | |
| | of the ink cavity. | | | |
| Nozzle | A microfabricated | Can clear | Accurate | Silverbrook, |
| clearing | plate is pushed | severely clogged | mechanical | EP 0771 658 A2 |
| plate | against the | nozzles | alignment is | and related |
| | nozzles. The plate | | required | patent |
| | has a post for | | Moving parts | applications |
| | every nozzle. A | | are required | |
| | post moves | | There is risk | |
| | through each | | of damage to the | |
| | nozzle, displacing | | nozzles | |
| | dried ink. | | Accurate | |
| | | | fabrication is | |
| | | | required | |
| Ink | The pressure of the | May be | Requires | May be used |
| pressure | ink is temporarily | effective where | pressure pump | with all IJ series |
| pulse | increased so that | other methods | or other pressure | ink jets |
| | ink streams from | cannot be used | actuator | |
| | all of the nozzles. | | Expensive | |
| | This may be used | | Wasteful of | |
| | in conjunction | | ink | |
| | with actuator | | | |
| | energizing. | | | |
| Print | A flexible ‘blade’ | Effective for | Difficult to | Many ink jet |
| head | is wiped across the | planar print head | use if print head | systems |
| wiper | print head surface. | surfaces | surface is non- | |
| | The blade is | Low cost | planar or very | |
| | usually fabricated | | fragile | |
| | from a flexible | | Requires | |
| | polymer, e.g. | | mechanical parts | |
| | rubber or synthetic | | Blade can | |
| | elastomer. | | wear out in high | |
| | | | volume print | |
| | | | systems | |
| Separate | A separate heater | Can be | Fabrication | Can be used |
| ink | is provided at the | effective where | complexity | with many IJ |
| boiling | nozzle although | other nozzle | | series ink jets |
| heater | the normal drop e- | clearing methods | | |
| | ection mechanism | cannot be used | | |
| | does not require it. | Can be | | |
| | The heaters do not | implemented at | | |
| | require individual | no additional | | |
| | drive circuits, as | cost in some ink | | |
| | many nozzles can | jet | | |
| | be cleared | configurations | | |
| | simultaneously, | | | |
| | and no imaging is | | | |
| | required. | | | |

NOZZLE PLATE CONSTRUCTION

| | Description | Advantages | Disadvantages | Examples |
|---|---|---|---|---|
| Electro- | A nozzle plate is | Fabrication | High | Hewlett |
| formed | separately | simplicity | temperatures and | Packard Thermal |
| nickel | fabricated from | | pressures are | Ink jet |
| | electroformed | | required to bond | |
| | nickel, and bonded | | nozzle plate | |
| | to the print head | | Minimum | |
| | chip. | | thickness | |
| | | | constraints | |
| | | | Differential | |
| | | | thermal | |
| | | | expansion | |
| Laser | Individual nozzle | No masks | Each hole | Canon |
| ablated or | holes are ablated | required | must be | Bubblejet |
| drilled | by an intense UV | Can be quite | individually | 1988 Sercel et |
| polymer | laser in a nozzle | fast | formed | al., SPIE, Vol. |
| | plate, which is | Some control | Special | 998 Excimer |
| | typically a | over nozzle | equipment | Beam |
| | polymer such as | profile is | required | Applications, pp. |
| | polyimide or | possible | Slow where | 76-83 |
| | polysulphone | Equipment | there are many | 1993 |
| | | required is | thousands of | Watanabe et al., |
| | | relatively low | nozzles per print | U.S. Pat. No. 5,208,604 |
| | | cost | head | |
| | | | May produce | |
| | | | thin burrs at exit | |
| | | | holes | |
| Silicon | A separate nozzle | High accuracy | Two part | K. Bean, |
| micro- | plate is | is attainable | construction | IEEE |
| machined | micromachined | | High cost | Transactions on |
| | from single crystal | | Requires | Electron |
| | silicon, and | | precision | Devices, Vol. |
| | bonded to the print | | alignment | ED-25, No. 10, |
| | head wafer. | | Nozzles may | 1978, pp 1185-1195 |
| | | | be clogged by | Xerox 1990 |
| | | | adhesive | Hawkins et al., |
| | | | | U.S. Pat. No. 4,899,181 |
| Glass | Fine glass | No expensive | Very small | 1970 Zoltan |
| capillaries | capillaries are | equipment | nozzle sizes are | U.S. Pat. No. 3,683,212 |
| | drawn from glass | required | difficult to form | |
| | tubing. This | Simple to | Not suited for | |
| | method has been | make single | mass production | |
| | used for making | nozzles | | |
| | individual nozzles, | | | |
| | but is difficult to | | | |
| | use for bulk | | | |
| | manufacturing of | | | |
| | print heads with | | | |
| | thousands of | | | |
| | nozzles. | | | |
| Monolithic, | The nozzle plate is | High accuracy | Requires | Silverbrook, |
| surface | deposited as a | (<1 μm) | sacrificial layer | EP 0771 658 A2 |
| micro- | layer using | Monolithic | under the nozzle | and related |
| machined | standard VLSI | Low cost | plate to form the | patent |
| using | deposition | Existing | nozzle chamber | applications |
| VLSI | techniques. | processes can be | Surface may | IJ01, IJ02, |
| litho- | Nozzles are etched | used | be fragile to the | IJ04, IJ11, IJ12, |
| graphic | in the nozzle plate | | touch | IJ17, IJ18, IJ20, |
| processes | using VLSI | | | IJ22, IJ24, IJ27, |
| | lithography and | | | IJ28, IJ29, IJ30, |
| | etching. | | | IJ31, IJ32, IJ33, |
| | | | | IJ34, IJ36, IJ37, |
| | | | | IJ38, IJ39, IJ40, |
| | | | | IJ41, IJ42, IJ43, |
| | | | | IJ44 |
| Monolithic, | The nozzle plate is | High accuracy | Requires long | IJ03, IJ05, |
| etched | a buried etch stop | (<1 μm) | etch times | IJ06, IJ07, IJ08, |
| through | in the wafer. | Monolithic | Requires a | IJ09, IJ10, IJ13, |
| substrate | Nozzle chambers | Low cost | support wafer | IJ14, IJ15, IJ16, |
| | are etched in the | No differential | | IJ19, IJ21, IJ23, |
| | front of the wafer, | expansion | | IJ25, IJ26 |
| | and the wafer is | | | |
| | thinned from the | | | |
| | back side. Nozzles | | | |
| | are then etched in | | | |
| | the etch stop layer. | | | |
| No nozzle | Various methods | No nozzles to | Difficult to | Ricoh 1995 |
| plate | have been tried to | become clogged | control drop | Sekiya et al U.S. Pat. No. |
| | eliminate the | | position | 5,412,413 |
| | nozzles entirely, to | | accurately | 1993 |
| | prevent nozzle | | Crosstalk | Hadimioglu et al |
| | clogging. These | | problems | EUP 550,192 |
| | include thermal | | | 1993 Elrod et |
| | bubble | | | al EUP 572,220 |
| | mechanisms and | | | |
| | acoustic lens | | | |
| | mechanisms | | | |
| Trough | Each drop ejector | Reduced | Drop firing | IJ35 |
| | has a trough | manufacturing | direction is | |
| | through which a | complexity | sensitive to | |
| | paddle moves. | Monolithic | wicking. | |
| | There is no nozzle | | | |
| | plate. | | | |
| Nozzle slit | The elimination of | No nozzles to | Difficult to | 1989 Saito et |
| instead of | nozzle holes and | become clogged | control drop | al U.S. Pat. No. |
| individual | replacement by a | | position | 4,799,068 |
| nozzles | slit encompassing | | accurately | |
| | many actuator | | Crosstalk | |
| | positions reduces | | problems | |
| | nozzle clogging, | | | |
| | but increases | | | |
| | crosstalk due to | | | |
| | ink surface waves | | | |

DROP EJECTION DIRECTION

| | Description | Advantages | Disadvantages | Examples |
|---|---|---|---|---|
| Edge | Ink flow is along | Simple | Nozzles | Canon |
| (‘edge | the surface of the | construction | limited to edge | Bubblejet 1979 |
| shooter’) | chip, and ink drops | No silicon | High | Endo et al GB |
| | are ejected from | etching required | resolution is | patent 2,007,162 |
| | the chip edge. | Good heat | difficult | Xerox heater- |
| | | sinking via | Fast color | in-pit 1990 |
| | | substrate | printing requires | Hawkins et al |
| | | Mechanically | one print head | U.S. Pat. No. 4,899,181 |
| | | strong | per color | Tone-jet |
| | | Ease of chip | | |
| | | handing | | |
| Surface | Ink flow is along | No bulk | Maximum ink | Hewlett- |
| (‘roof | the surface of the | silicon etching | flow is severely | Packard TIJ |
| shooter’) | chip, and ink drops | required | restricted | 1982 Vaught et |
| | are ejected from | Silicon can | | al U.S. Pat. No. |
| | the chip surface, | make an | | 4,490,728 |
| | normal to the | effective heat | | IJ02, IJ11, |
| | plane of the chip. | sink | | IJ12, IJ20, IJ22 |
| | | Mechanical | | |
| | | strength | | |
| Through | Ink flow is through | High ink flow | Requires bulk | Silverbrook, |
| chip, | the chip, and ink | Suitable for | silicon etching | EP 0771 658 A2 |
| forward | drops are ejected | pagewidth print | | and related |
| (‘up | from the front | heads | | patent |
| shooter’) | surface of the chip. | High nozzle | | applications |
| | | packing density | | IJ04, IJ17, |
| | | therefore low | | IJ18, IJ24, IJ27-IJ45 |
| | | manufacturing | | |
| | | cost | | |
| Through | Ink flow is through | High ink flow | Requires | IJ01, IJ03, |
| chip, | the chip, and ink | Suitable for | wafer thinning | IJ05, IJ06, IJ07, |
| reverse | drops are ejected | pagewidth print | Requires | IJ08, IJ09, IJ10, |
| (‘down | from the rear | heads | special handling | IJ13, IJ14, IJ15, |
| shooter’) | surface of the chip. | High nozzle | during | IJ16, IJ19, IJ21, |
| | | packing density | manufacture | IJ23, IJ25, IJ26 |
| | | therefore low | | |
| | | manufacturing | | |
| | | cost | | |
| Through | Ink flow is through | Suitable for | Pagewidth | Epson Stylus |
| actuator | the actuator, which | piezoelectric | print heads | Tektronix hot |
| | is not fabricated as | print heads | require several | melt |
| | part of the same | | thousand | piezoelectric ink |
| | substrate as the | | connections to | jets |
| | drive transistors. | | drive circuits | |
| | | | Cannot be | |
| | | | manufactured in | |
| | | | standard CMOS | |
| | | | fabs | |
| | | | Complex | |
| | | | assembly | |
| | | | required | |

INK TYPE

| | Description | Advantages | Disadvantages | Examples |
|---|---|---|---|---|
| Aqueous, | Water based ink | Environmentally | Slow drying | Most existing |
| dye | which typically | friendly | Corrosive | ink jets |
| | contains: water, | No odor | Bleeds on | All IJ series |
| | dye, surfactant, | | paper | ink jets |
| | humectant, and | | May | Silverbrook, |
| | biocide. | | strikethrough | EP 0771 658 A2 |
| | Modern ink dyes | | Cockles paper | and related |
| | have high water- | | | patent |
| | fastness, light | | | applications |
| | fastness | | | |
| Aqueous, | Water based ink | Environmentally | Slow drying | IJ02, IJ04, |
| pigment | which typically | friendly | Corrosive | IJ21, IJ26, IJ27, |
| | contains: water, | No odor | Pigment may | IJ30 |
| | pigment, | Reduced bleed | clog nozzles | Silverbrook, |
| | surfactant, | Reduced | Pigment may | EP 0771 658 A2 |
| | humectant, and | wicking | clog actuator | and related |
| | biocide. | Reduced | mechanisms | patent |
| | Pigments have an | strikethrough | Cockles paper | applications |
| | advantage in | | | Piezoelectric |
| | reduced bleed, | | | ink-jets |
| | wicking and | | | Thermal ink |
| | strikethrough. | | | jets (with |
| | | | | significant |
| | | | | restrictions) |
| Methyl | MEK is a highly | Very fast | Odorous | All IJ series |
| Ethyl | volatile solvent | drying | Flammable | ink jets |
| Ketone | used for industrial | Prints on | | |
| (MEK) | printing on | various | | |
| | difficult surfaces | substrates such | | |
| | such as aluminum | as metals and | | |
| | cans. | plastics | | |
| Alcohol | Alcohol based inks | Fast drying | Slight odor | All IJ series |
| (ethanol, | can be used where | Operates at | Flammable | ink jets |
| 2-butanol, | the printer must | sub-freezing | | |
| and | operate at | temperatures | | |
| others) | temperatures | Reduced | | |
| | below the freezing | paper cockle | | |
| | point of water. An | Low cost | | |
| | example of this is | | | |
| | in-camera | | | |
| | consumer | | | |
| | photographic | | | |
| | printing. | | | |
| Phase | The ink is solid at | No drying | High viscosity | Tektronix hot |
| change | room temperature, | time-ink | Printed ink | melt |
| (hot melt) | and is melted in | instantly freezes | typically has a | piezoelectric ink |
| | the print head | on the print | ‘waxy’ feel | jets |
| | before jetting. Hot | medium | Printed pages | 1989 Nowak |
| | melt inks are | Almost any | may ‘block’ | U.S. Pat. No. 4,820,346 |
| | usually wax based, | print medium | Ink | All IJ series |
| | with a melting | can be used | temperature may | ink jets |
| | point around 80° C. | No paper | be above the | |
| | After jetting | cockle occurs | curie point of | |
| | the ink freezes | No wicking | permanent | |
| | almost instantly | occurs | magnets | |
| | upon contacting | No bleed | Ink heaters | |
| | the print medium | occurs | consume power | |
| | or a transfer roller. | No | Long warm- | |
| | | strikethrough | up time | |
| | | occurs | | |
| Oil | Oil based inks are | High | High | All IJ series |
| | extensively used in | solubility | viscosity: this is | ink jets |
| | offset printing. | medium for | a significant | |
| | They have | some dyes | limitation for use | |
| | advantages in | Does not | in ink jets, which | |
| | improved | cockle paper | usually require a | |
| | characteristics on | Does not wick | low viscosity. | |
| | paper (especially | through paper | Some short | |
| | no wicking or | | chain and multi- | |
| | cockle). Oil | | branched oils | |
| | soluble dies and | | have a | |
| | pigments are | | sufficiently low | |
| | required. | | viscosity. | |
| | | | Slow drying | |
| Micro- | A microemulsion | Stops ink | Viscosity | All IJ series |
| emulsion | is a stable, self | bleed | higher than | ink jets |
| | forming emulsion | High dye | water | |
| | of oil, water, and | solubility | Cost is | |
| | surfactant. The | Water, oil, | slightly higher | |
| | characteristic drop | and amphiphilic | than water based | |
| | size is less than | soluble dies can | ink | |
| | 100 nm, and is | be used | High | |
| | determined by the | Can stabilize | surfactant | |
| | preferred curvature | pigment | concentration | |
| | of the surfactant. | suspensions | required (around | |
| | | | 5%) | |

1. A method of hydrophobizing an ejection face of a printhead, whilst avoiding hydrophobizing fluid distribution structures of the printhead, the method comprising the steps of:
(a) filling fluid distribution structures of the printhead exposed to the ejection face with a liquid; and
(b) depositing a hydrophobizing material onto the ejection face of the printhead, provided that step (a) is performed prior to step (b).

2. A method according to claim 1, wherein the fluid distribution structures comprise ejection nozzle chambers and fluid supply channels of the printhead.

3. A method according to claim 2 wherein the liquid is an inkjet ink.

4. A method according to claim 3,wherein step (a) includes priming the chambers with the inkjet ink.

5. A method according to claim 1, wherein the deposition of step (b) is chemical vapor deposition.

6. A method according to claim 1, wherein the ejection face comprises atoms available for covalent bonding with the hydrophobizing material.

7. A method according to claim 6, wherein the atoms are oxygen or nitrogen atoms.

8. A method according to claim 6, wherein the hydrophobizing material forms covalent bonds with the ejection face.

9. A method according to claim 6, wherein the ejection face is comprised of a material selected from silicon nitride, silicon oxide or silicon oxynitride.
